(19) United States
(12) Patent Application Publication
(10) Pub. No.: US 2011/0314914 A1
(43) Pub. Date: Dec. 29, 2011

(54) ACOUSTIC OSCILLATOR

(76) Inventors: John Francis Gregg, Oxford (GB); Alexy Davison Karenowska, Oxford (GB); Constantin-Cassios Coussios, Oxford (GB)

(21) Appl. No.: 13/144,888

(22) PCT Filed: Jan. 18, 2009
(86) PCT No.: PCT/GB2010/000069

§ 371 Date: Sep. 13, 2011

(30) Foreign Application Priority Data
Jan. 16, 2009 (GB) 0900745.1

(51) Int. Cl. G01H 17/00

(52) U.S. Cl. 73/570.5

(57) ABSTRACT

An acoustic oscillator arrangement includes an acoustic system having at least one acoustic transmission path through it, and at least one mode. The acoustic transmission path is of variable length. A controller is provided with an amplifier and a feedback network which together provide a positive feedback oscillator for exciting a mode of the acoustic system. The feedback network comprises a non linear amplitude control element (N-LACE), a frequency dependent gain element with an electronic transfer function, and a phase compensator. The acoustic oscillator arrangement also includes an acoustic transmitter which launches an acoustic signal into the acoustic system based upon an output from the controller, and an acoustic receiver which receives an acoustic signal from the acoustic system which is fed back to the controller. Such a stabilized positive feedback arrangement is self exciting at the effective resonance frequency of the acoustic system and avoids the need for an external fixed or variable frequency driver.

### FIELD OF THE INVENTION

This invention relates to an acoustic oscillator device.

### BACKGROUND OF THE INVENTION

The development of acoustic oscillator devices—systems designed for the sustained constant-amplitude resonant excitation of acoustic structures—began around the turn of the 20^{th} Century. A recent upsurge in interest in the design of systems to generate and maintain acoustic standing waves within or along resonant acoustic structures—particularly at ultrasonic frequencies—has been fuelled at least in part by the acknowledged potential of acoustic levitation and filtration devices and so-called ‘acoustic tweezers’ to provide solutions to contemporary challenges in micro and nano-fluidics (particularly in the emerging nanotech and bionanotech sectors) see for example “A pi-shaped ultrasonic tweezers concept for manipulation of small particles” IEEE Trans. UFFC, 51(11):1499-1507, November 2004. Moreover, resonant surface and bulk acoustic wave (BAW/SAW) structures find increasing use in macro, micro and nano-automation and non-destructive, non-invasive materials testing and characterization see for example “Broadband acoustical tuning of nano-electromechanical sensors” by Beil, Wixforth and Blick, Sensors 2002, Proc. IEEE 2002.

A general acoustic oscillator device comprises two essential functional parts: an acoustic structure with at least one resonant mode, and a control system. The purpose of the control system is to arrange that the acoustic structure is excited at a frequency co-incident (or very nearly co-incident) with the frequency of the resonant mode. Although conceptually simple, realizing practical systems with this functionality is non-trivial. Two main difficulties are encountered: firstly, the acoustic structures of interest typically feature very sharply defined acoustic resonances (i.e. they are high quality factor (Q) systems); and secondly, the structures are usually multimoded, that is, they feature not one single resonant mode, but a collection or ‘family’ of modes which may be relatively closely spaced in frequency.

Prior art acoustic oscillator devices employ various control systems but the majority are fundamentally negative-feedback ‘driven oscillators’: the acoustic structure is driven via an external frequency source which is—hopefully—tuned to the required operating frequency. Open-loop manual tuning systems are relatively widespread. More sophisticated closed-loop systems use Phase-Sensitive-Detection as is described, for example, in U.S. Pat. No. 4,758,803.

An alternative family of tuning methods have their basis in monitoring the electrical impedance of the acoustic system, either manually using bridge techniques (see for example “Extension of acoustic levitation to include the study of micron-size particles in a more compressible host liquid” J. Acoust. Soc. Am., 71(5):1261-1268, 1982, by Weiser et al, or automatically, employing digital components and a pre-programmed logical ‘seek’ loop such as is described in “Versatile resonance tracking circuit for acoustic levitation experiments” Rev. Sci. Instrum., 49(2):224-226, 1978, by Baxter et al.

However, severe difficulties are encountered with all of these arrangements if the frequency corresponding to the resonant mode of the acoustic structure is not constant. The ‘mode-tracking’ capability and of all prior art acoustic oscillator device control systems is severely limited, and generally becomes increasingly poor, the higher the Q of the acoustic structure. This lack of tracking capacity and a more general problem of noise susceptibility, constitute major obstacles to the development of high-performance acoustic oscillator device based technologies.

### SUMMARY OF THE INVENTION

Against this background, and in accordance with a first aspect of the present invention, there is provided an acoustic oscillator arrangement as set out in claim 1.

Such a stabilized positive feedback arrangement is self exciting at the preferred oscillating frequency of the system and avoids the need for an external fixed or variable frequency driver. Moreover, by providing an adjustable transmission path length in the acoustic system (for example by mounting the acoustic transmitter and/or receiver for movement relative to one another), and/or by providing within the controller a means for varying an electrical frequency dependent transfer function, the arrangement is capable of establishing (and desirably operates with) both standing and travelling (propagating) acoustic waves. Certain preferred embodiments of this invention (such as arrangements configured for bulk sample analysis) employ substantially propagating waves whilst other arrangements (such as “acoustic tweezers”) employ substantially standing waves. In each case, however, the system establishes a subsidiary wave type as well as the primary wave type: where standing waves are primarily present, some propagating waves are also present and vice versa.

Employing both standing and travelling waves together, and in controllable proportions to one another (rather than, as in prior art arrangements, seeking to maximize one type of wave or another) provides for improved control. In particular most distributed-parameter acoustic systems do not have a single resonance frequency but instead comprise a family of modes. Embodiments of the present invention enable a particular one of these modes to be selected and locked on to (that is, the controller allows for more than simple resonant excitation of the acoustic system), provided that the acoustic receiver is correctly located in the acoustic path and that the frequency dependent gain element has an appropriate transfer function.

In summary, the arrangement of the present invention permits “mode selection”, “mode-tracking” and, in certain embodiments, “mode switching” in conjunction with distributed-parameter acoustic structures (acoustic structures comprising one or more acoustic transmission paths with a characteristic dimension (i.e. a length in the principle direction of acoustic propagation) comparable to the acoustic wavelength at the operating frequency). A brief summary of these three different aspects of the functionality of acoustic oscillators embodying aspects of the present invention is now given, together with some definitions of terms which will be used in the description that follows.

“Mode selection”: The ‘preferred operating frequency’ of a given implementation of the acoustic oscillator is the frequency at which the loop gain provided by the combination of the controller and the acoustic system is unity and the total loop phase shift is substantially zero (or substantially an integer multiple of 360 degrees). Predictable, well mannered behaviour of the most general form of oscillator described by the invention is achieved by making provision for these two conditions to be met at and only at a frequency which corresponds to a single resonant mode of the acoustic structure.

As already stated, the distributed-parameter acoustic structures relevant to the invention almost always feature not one, but a family of resonant modes. Arranging that one of these defines the ‘preferred operating frequency’ requires that a) the receiver is in the correct location along the acoustic transmission path b) the frequency dependent gain element has an appropriate transfer function and c) that the amplitude regulator element has the particular set of characteristics that will be laid out in subsequent sections.

“Mode-tracking” may further be achieved by providing a frequency dependent gain element within the oscillator controller or in an additional signal processing element which is designed in conjunction with the acoustic structure in such a way that the closed-loop arrangement is capable of supplying unity gain and substantially zero (or substantially 360n where n is an integer) loop phase shift over a certain range of frequencies which corresponds to the range over which the mode might move. In general, this range is of order the mode frequency divided by the Q of the acoustic structure (and therefore except in exceptional cases, substantially less than the “inter-mode” spacing).

In certain embodiments of the acoustic oscillator invention, “mode switching” may further be achieved by imposing a change either: a) in the electronic transfer function of the frequency dependent gain element that is present in the acoustic oscillator controller, b) in the electronic or acoustic transfer function of additional ‘signal processing elements’ that are external both to the controller and the acoustic system, or c) the relative positions of the acoustic receiver, acoustic source (or reflector if there is one, or other acoustic structure components). Mode switching involves switching between an oscillator configuration which satisfies the ‘mode selection’ conditions described above at one modal frequency f1 to a frequency f2 (or f3 . . . fn) corresponding to another. In practice, this is achieved by one or a combination of the mechanisms a)-c) changing the relationship between the frequency dependent phase shift and/or gain provided by the ‘controller’ (or the controller plus additional signal processing elements) and the phase shift and attenuation inherent in the acoustic structure

Certain embodiments of the acoustic oscillator combine the functionalities of “mode-tracking” and “mode switching”.

A non-linear amplitude control element performs the function of amplitude regulation in the oscillator feedback path, providing both a gain and a non-linearity. Either the non-linearity is provided by a particular arrangement of active components or by the inherent physical properties of a non-linear circuit component or selection of components. Desirably, the element provides at least some and preferably all of the following 4 characteristics:

A a small-signal dynamic gain with a large constant value which may or may not be dependent upon the polarity of the input signal;

B a small-signal quasi-linear signal regime which is approximately entirely linear;

C a strongly non-linear signal regime which features a zero large-signal dynamic gain; and

D a narrow and preferably negligibly wide transitional regime separating the quasi-linear and strongly non-linear signal regimes.

The magnitude of the non-linear amplitude control element output preferably increases monotonically with that of the input, and, in the limit of large input, the output signal has a magnitude with a negative second derivative with respect to the input signal. The characteristic might have a negative second derivative with respect to the input for all magnitudes of input signal—i.e. the output may take a certain initial value for the limit of very small input amplitude, and this value may then increase monotonically to a constant value in a non-linear fashion with increasing input. Alternatively, for values of input signal up to some limit, the gain or transconductance of the element might be constant (i.e. the second derivative of output with respect to input zero), then gradually reduce.

Various applications of the acoustic oscillator device of the present invention are envisaged. In a first embodiment, a bulk substance analysis/detection device may be provided by providing, as an acoustic system, the bulk material to be analysed—for example for the purposes of detecting cracks or monitoring fatigue/failure in solid structures. In such an embodiment, a substantially travelling wave is preferably employed, that is, a travelling wave is employed but some standing waves are also deliberately present.

In alternative preferred embodiments, the arrangement of the present invention may be used for acoustic levitation or filtration, or acoustic manipulation (“acoustic tweezers”). These embodiments by contrast preferably provide a bounded (defined) container, receptacle or housing for example, that defines the acoustic structure. Substantially standing acoustic waves (that is, standing waves plus some travelling waves) are then launched into the acoustic structure which may contain a fluid to be filtered for example.

In the following, the term “acoustic wave” is employed. This is intended to be interpreted in the most general sense of a longitudinal wave, a shear wave, a Rayleigh wave or the like that is supported or supportable within a viscoelastic medium, and is of a frequency that is below, within or above the range of human hearing (c. 20 Hz-20,000 Hz).

Further features and advantages of the present invention will be apparent from the appended claims and the following description.

### BRIEF DESCRIPTION OF THE DRAWINGS

FIGS. 1A and 1B show alternative arrangements of an acoustic oscillator device embodying the present invention, in its most general form and having a controller;

FIGS. 2A and 2B show modified arrangements of the device of FIGS. 1A and 1B respectively;

FIG. 3 shows the controller of FIGS. 1 and 2 in further detail, including a non-linear amplitude control element (N-LACE);

FIGS. 4A, 4B and 4C illustrate some equivalent electrical circuits for the acoustic oscillator device of FIGS. 1A and 1B respectively;

FIG. 5 shows an idealised optimal small and large signal input-output characteristic of the N-LACE of FIG. 3;

FIG. 6A shows an idealised small and large signal input-output characteristic of the N-LACE of FIG. 3, and FIGS. 6B-6D show different less optimal input-output characteristics thereof;

FIG. 6E shows the small and large signal input-output characteristics of a non-linear amplitude control element which has undesirable characteristics;

FIG. 7A shows a circuit diagram exemplifying one implementation of the N-LACE of FIG. 3;

FIG. 7B shows a circuit diagram exemplifying a further implementation of the N-LACE of FIG. 3;

FIG. 8 shows a circuit diagram exemplifying still another implementation of the N-LACE of FIG. 3;

FIG. 9 shows a circuit diagram of a phase compensator as an example of a realization of a the phase compensator in the controller of FIG. 3;

FIG. 10 shows schematically an arrangement employing the acoustic oscillator device of FIG. 1 or 2, for measuring/analysing bulk materials and employing substantially travelling waves;

FIG. 11 shows in further schematic detail the different ways in which acoustic waves of different types may travel through acoustic structures in accordance with alternative embodiments of the present invention;

FIG. 12 shows schematically an arrangement employing the acoustic oscillator device of FIG. 1 or 2, for acoustic levitation, and employing substantially standing waves;

FIG. 13 shows schematically an arrangement employing the acoustic oscillator device of FIG. 1 or 2, incorporated into acoustic manipulators or tweezers and employing substantially standing waves;

FIG. 14 shows schematically an arrangement employing the acoustic oscillator device of FIG. 1 or 2, for acoustic filtration, and employing substantially standing waves;

FIGS. 15A-15D show plots of the real vs imaginary parts of the acoustic pressure distribution in a one-dimensional lossless acoustic transmission line, for various angles, for a first set of conditions; and

FIGS. 16A-16D show plots of the real vs imaginary parts of the acoustic pressure distribution of an acoustic waves in a one-dimensional lossless acoustic transmission line, for various angles, for a second set of conditions.

### DETAILED DESCRIPTION OF A PREFERRED EMBODIMENT

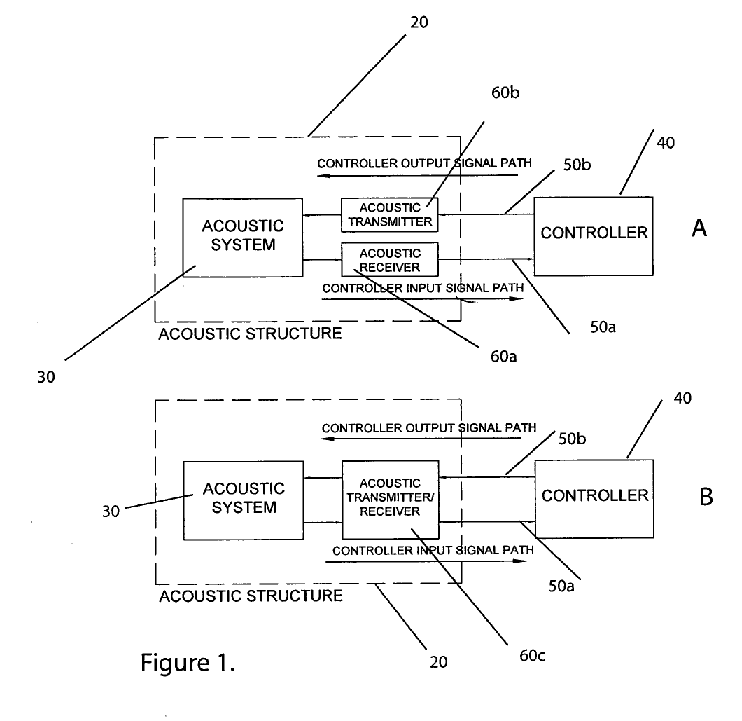

FIGS. 1A and 1B show, at a most general level, the structure of an acoustic oscillator device 10 embodying the present invention. In each case, the acoustic oscillator device comprises an acoustic structure 20 which includes an acoustic system 30. This is the functional part or active region of the acoustic oscillator device 10, which lends functionality to a particular implementation of the acoustic oscillator device. Its exact nature depends on the desired functionality of that acoustic oscillator device.

As shown in FIG. 1A, the acoustic system 30 is coupled to an oscillator controller 40 by separate controller input and output components 50a, 50b. Within the output component 50b from the controller 40 is an acoustic transmitter 60b. The acoustic transmitter 60b provides the output coupling between the controller 40 and the acoustic system 30. The acoustic transmitter 60b comprises or incorporates a sound source which, in the embodiment of FIG. 1A, is distinct from an acoustic receiver 60a. The acoustic transmitter 60b may take many forms depending on the oscillator implementation, but generally comprises or incorporates a piezoelectric acoustic transducer (e.g. a Lead Zirconate Titanate (PZT) transducer). The acoustic receiver 60a may likewise take many forms depending on the oscillator implementation, e.g. a microphone, hydrophone, or piezoelectric transducer.

The controller 40 provides amplification, amplitude regulation phase-compensation, and mode-selection functions such that, in combination with the acoustic structure 20, a system satisfying all the requirements of a positive-feedback controlled oscillatory system is created. More particularly, it may be observed that any acoustic oscillator device system has a certain ‘preferred operating frequency’. In operation, energy is supplied to the acoustic structure 20 at the preferred operating frequency, and stable, constant amplitude operation of the acoustic oscillator device 10 at this frequency is maintained.

Moreover, in contrast to previous acoustic oscillator device instruments which incorporate an external fixed or variable frequency driver, the various arrangements of preferred embodiments of the present invention do not have such an external driver and instead are self-exciting at the preferred operating frequency.

Furthermore, a particular feature of the present acoustic oscillator invention is that the ‘effective acoustic path length’ between acoustic transmitter and receiver components is variable. This variation may be achieved either via relative motion of the transmitter and receiver components, or some externally or internally imposed change in the geometry of the acoustic structure.

In general terms, the acoustic oscillator device 10 of embodiments of the present invention operates as follows. At switch-on, the acoustic oscillator device 10 responds to the component of a weak exciting signal (for example background electrical, acoustic or thermal noise) at its preferred operating frequency. The response to this weak signal is received by the acoustic receiver 60a. The phase of the response signal received by the receiver component is dependent on its location in the acoustic structure and the length of the effective path between the transmitter and receiver components. The signal from the acoustic receiver 60a is preferentially amplified around the positive-feedback oscillator control-loop and amplitude-stable operation of the acoustic oscillator device 10 at a pre-set level rapidly established.

FIG. 1B shows an alternative arrangement of the generalised acoustic oscillator device structure of FIG. 1A. In contrast to the separate acoustic transmitter 60b and acoustic receiver 60a, on separate controller output and input paths 50b, 50a respectively, the arrangement of FIG. 1B employs a combined transmitter/receiver module 60c, capable of both transmitting signals to the acoustic system 30 and receiving signals back from it, with two way communication along separate controller output and input connections 50b, 50a respectively.

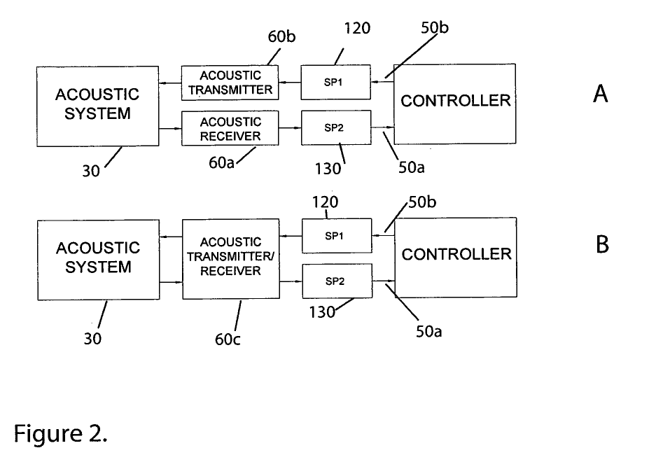

Although the most general form of the acoustic oscillator device 10 embodying the present invention is illustrated by the embodiments of FIGS. 1A and 1B, certain implementations of the acoustic oscillator device 10 may also incorporate signal processing elements 130, 120 in the input and output signal paths 50a, 50b as well. FIG. 2A shows additional signal processing elements 120, 130 included in the controller output 50b and controller input 50a paths respectively of the arrangement of FIG. 1A, whereas FIG. 2B shows an implementation in which separate signal processing elements are employed in the separate controller output and input paths 50b, 50a of the arrangement of FIG. 1B, where the acoustic transmitter and receiver are combined into the single unit 60c. Although FIGS. 2A and 2B show signal processing elements 130, 120 in both controller input and output paths 50a, 50b, it will be appreciated, of course, that such signal processing elements may be located in only one of the input or output paths instead.

Signal processing elements 130, 120 which might be included in either or both of the input and output signal paths 50a, 50b include for example, filters, phase-compensation units and amplifiers.

The means by which oscillator stabilization and control are effected in the general acoustic oscillator device 10 embodying the present invention and as outlined above, is distinct from that of prior art devices. In a particular implementation of the acoustic oscillator device 10, the functional part or active region of the acoustic structure 20 supports a combination of standing and propagating acoustic waves. The relative proportions of standing and propagating acoustic waves is controlled by the adjustment of the effective acoustic path length (as above defined), and/or the variation of an electrical frequency dependent transfer function incorporated into the oscillator controller 40 or appearing in a separate signal processing element 120, 130.

The reception of standing and propagating acoustic waves by the acoustic receiver 60a is important to the correct functioning of the device 10 which accords with the present invention. To understand why this should be so, it is helpful to recognize the acoustic structure as a distributed-parameter acoustic system as already defined. Moreover, the acoustic structures relevant to the acoustic oscillator device are ‘low loss’; i.e. the total acoustic attenuation in the transmission path(s) which constitutes the acoustic structure is insignificant. The distributed-parameter acoustic structures relevant to embodiments of the present invention may be described in terms of networks of acoustic ‘delay-lines’ with each component of the acoustic structure being represented by a section of acoustic ‘transmission line’ with some characteristic acoustic impedance Zᵢ and characteristic length lᵢ.

Acoustic propagation in the acoustic structure 20 may be modelled by considering an acoustic disturbance propagating along a single homogeneous length of lossless one dimensional acoustic delay-line (i.e. the simplest possible acoustic transmission line system which might constitute the active region of an acoustic structure 20 in the context of the present invention).

A pressure perturbation p′(z,t) propagating in the z direction along a one-dimensional lossless acoustic transmission line with equilibrium density ρ and pressure p is described by

$$\frac{1}{{c}^{2}} \frac{{\partial }^{2} {p}^{′}}{\partial {t}^{2}} = \frac{{\partial }^{2} {p}^{′}}{\partial {z}^{2}} , \qquad ( 1 )$$

where t and z denote time and position respectively, and c is the speed of sound. Solutions to equation (1) are summations of forward (p_{F}e^{j(ωt-kz)}) and reverse (p_{R}e^{j(ωt-kz)}) propagating pressure phasors:

p(z,t)=p_{F}e^{j(ωt-kz)}+p_{R}e^{j(ωt-kz)}, (2)

where k is the acoustic wavenumber

$$\frac{ω}{c} .$$

The pressure distribution of equation (2) may be recast in the form:

$$\begin{matrix}p ( z , t ) = {e}^{jω t} ( {p}_{F} {e}^{- j kz} + {p}_{R} {e}^{+ j kz} ) \\ = {e}^{jω t} ( \frac{{p}_{F} + {p}_{R}}{2} ( {e}^{+ j kz} + {e}^{- j kz} ) - \frac{{p}_{F} - {p}_{R}}{2} ( {e}^{+ j kz} - {e}^{- j kz} ) ) .\end{matrix} \qquad ( 3 )$$

Substituting:

(p_{F}+p_{F})=\tilde{K} cos φ, (4a)

(p_{F}−p_{R})=\tilde{K} sin φ, (4b)

where \tilde{K} is a positive constant greater than zero and the angle φ is defined in the interval 0≦φ≦90 degrees and

K=\tilde{K}e^{jωt}, (4c)

into equation (3), allows the pressure distribution to be expressed in the form

p(z,t)=K cos φ cos kz+jK sin φ sin kz. (5)

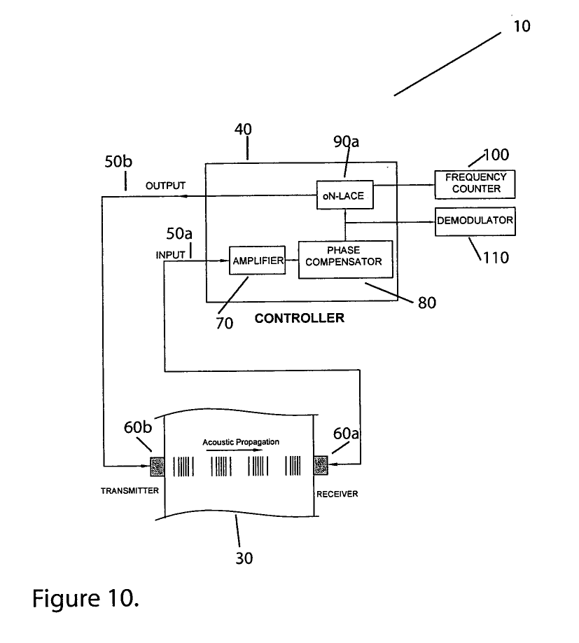

The angle φ is dependent on the relative magnitudes of forward and reverse pressure phasors (note that φ is everywhere specified in units of degrees). Pure standing wave solutions of equation (1) correspond to values of φ of zero and 90 degrees. Values of φ in the region 0<φ<90 correspond to a mixture of standing and propagating pressure waves. As explained above, desirably arrangements embodying the present invention employ a combination of standing and propagating acoustic waves in the acoustic structure. i.e. 0<φ<90. Depending on the desired functionality of the acoustic oscillator device (regarding which, see FIGS. 10 to 14 for some examples), the acoustic structure 20 and controller 40 may be designed so as to promote either substantially propagating (φ˜45 degrees but φ≠45 degrees) or substantially standing waves (φ˜0 or φ˜90 but φ≠0;φ≠90) within the functional part of the acoustic structure 20.

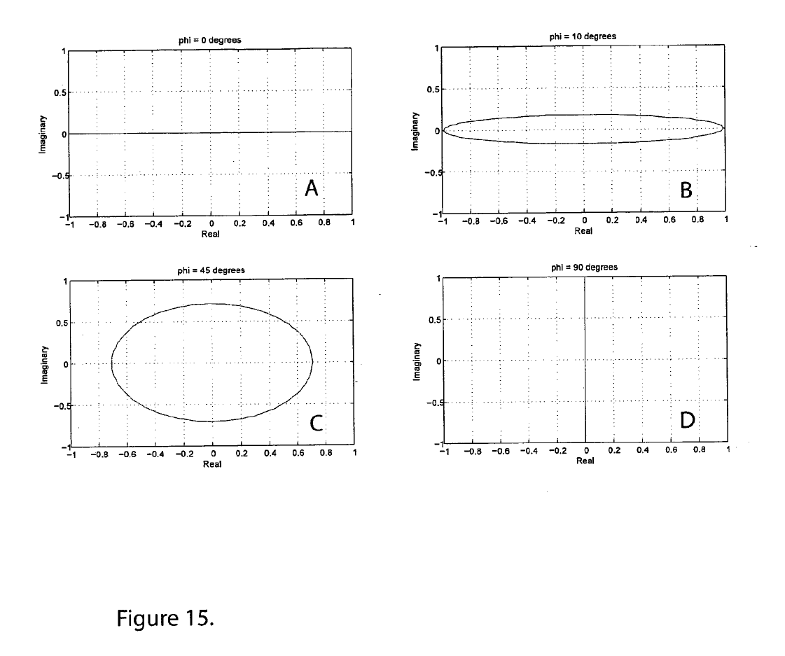

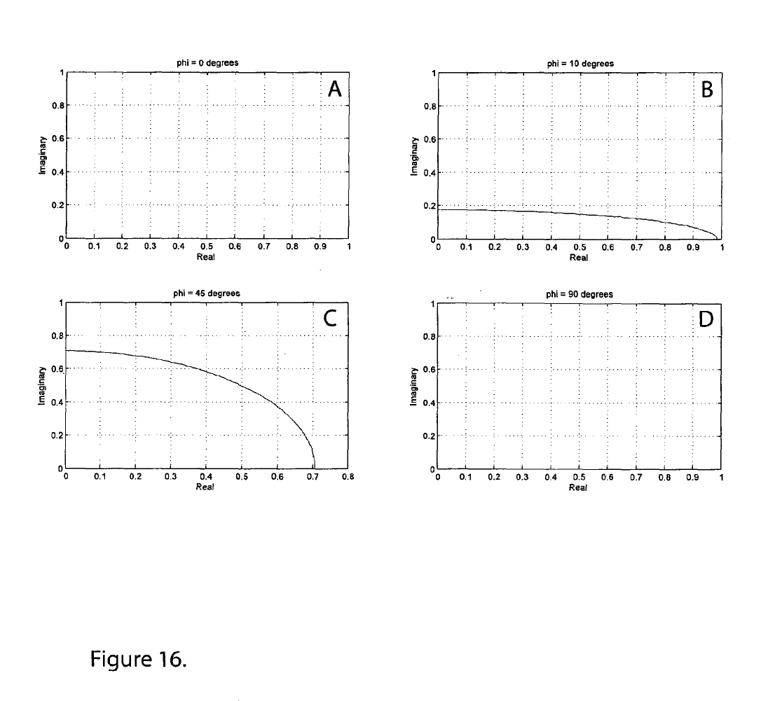

FIG. 15 shows plots of the real and imaginary components of (5) for values of kz between zero and 360 degrees. The data correspond to a particular instant in time t₁ for which e^{jωt}^{₁}=1 and the four separate plots are for four different values of φ: FIG. 15A, φ=0, FIG. 15B, φ=10, FIG. 15C, φ=45 and FIG. 15D, φ=90. FIG. 16 is these same data plotted for values of kz between zero and 90 degrees. The cases of φ=0, and φ=90 (FIGS. 15A, 15D, 16A, 16D) correspond to pure standing waves within the acoustic structure and accordingly purely real (φ=0) and purely imaginary (φ=90) p(z,t₁) i.e. respectively horizontal and vertical lines on the plots. In the cases that 0<φ<90, p(z,t₁) describes a closed elliptical path in the complex plane. In the special case that φ=45 (FIGS. 15C and 16C), the path is circular, reflecting the fact that at any point along the acoustic path, the real and imaginary components of p(z,t₁) have equal magnitude.

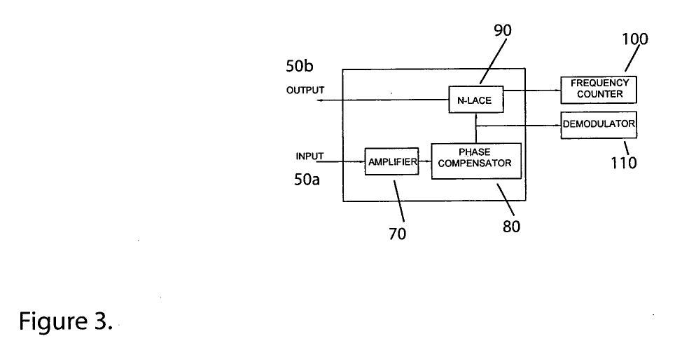

FIG. 3 shows a block diagram of the acoustic oscillator device controller 40 of FIGS. 1A, 1B, 2A and 2B in more detail. The controller 40 incorporates an amplifier 70, a phase compensator 80 and non-linear amplitude control element (N-LACE) 90 which, in the preferred embodiment of the present invention (see later detailed description), is an optimal non-linear amplitude controller (“oN-LACE”). This oN-LACE 90a is particularly preferred as a means for providing oscillator stabilization. These constituent elements of the controller 40 are the minimum elements required for the functioning of the acoustic oscillator device 10. Other electronic components may also be incorporated into the controller 40. An example of an additional electronic element which might be incorporated into the controller 40 is a component which provides a fixed or variable frequency dependent electronic transfer function.

The characteristics of the N-LACE 90, together with some examples of circuits providing these characteristics, are set out in further detail below. In general terms, however, it may be noted that the non-linear characteristics of the N-LACE 90 might be obtained using a variety of instrumentation techniques: the element may comprise or incorporate an active device with a negative differential conductance by virtue of a physical positive-feedback process. Alternatively, the desired non-linear characteristic may be achieved via a positive-feedback amplifier configuration.

At least one amplifier component (shown in FIG. 3 as a single block 70) appears at the input 50a to the controller 40 from the acoustic structure 20. Additional (optional) amplifier components may also be included in the controller 40. For example, an additional amplifier component (not shown) may appear at the output 50b of the controller 40.

Outputs related to the frequency and level (amplitude) of the oscillator's operation may be extracted; this is indicated in FIG. 3 by the presence of the frequency counter 100 and demodulator 110.

Subsequent figures will illustrate particular implementations of the generalised structures of FIGS. 1A, 1B, 2A and 2B. Whilst these particular implementations are linked by the common concept of having distributed-parameter acoustic structures, they nevertheless sub divide into two categories, those in which the acoustic structure supports a substantially propagating acoustic wave: ‘propagating wave systems’ and those in which the acoustic structure supports a substantially standing acoustic wave: ‘standing wave systems’. The systems may be designed so as to promote one or other of these types of waves in the acoustic structure, depending on the intended implementation (see below for some examples). However, in contrast to prior art devices, in substantially standing wave embodiments of the present invention, it is deliberately arranged that a small propagating wave component is nonetheless present. Similarly, in propagating wave systems, the presence of a small standing wave component is engineered. The relative proportions of standing and propagating acoustic waves is controlled by the adjustment of the effective acoustic path length in the acoustic structure 20, and/or the variation of an electrical frequency dependent transfer function incorporated into the oscillator controller 40 or appearing in a separate signal processing element. The small propagating and standing wave components in respectively substantially standing wave and propagating wave devices are received by the acoustic receiver 60a and used to stabilize respectively the (majority) standing/propagating acoustic components.

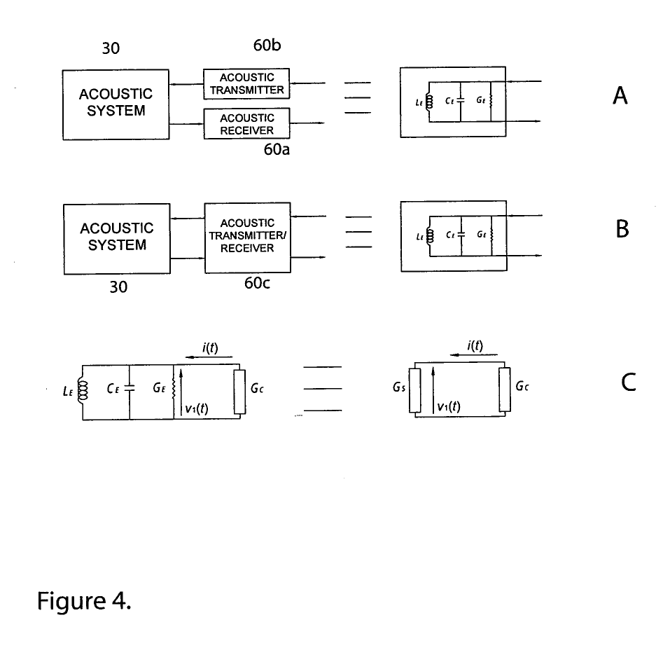

In accordance with preferred embodiments of the present invention, the oscillator instrumentation that drives the acoustic structure 20 is constituted in its most general sense of an active electronic amplifier, together with a phase compensator, a frequency dependent gain element having an electronic transfer function and amplitude regulator configured to provide a conditionally stable positive feedback loop. Appendix A derives the characteristics of the N-LACE 90 by treating the acoustic oscillator device 10 in terms of an entirely electrical equivalent circuit, as shown in FIGS. 4A, 4B and 4C.

In this representation, the instrument controller 40 incorporating the non-linear amplitude control element (N-LACE) 90 may be modelled by a shunt conductance G_{C} as depicted in FIG. 4C, and the operation of the acoustic oscillator device 10 may be described in terms of two time-dependent oscillator control signals: an equivalent current ‘output signal’ i(t) which flows into an impedance G_{S} (which represents the combined impedance of the acoustic structure 20 (when represented as an equivalent two terminal electrical circuit comprising three shunt elements: an effective inductance, capacitance and conductance), and originates from G_{C}, and an equivalent voltage ‘input signal’ ν₁(t) which appears across G_{S}. In general, G_{C} will be a complex, frequency dependent conductance with a negative real part and non-linear dependence on ν₁(t).

The function of the N-LACE 90 is to provide an amplitude regulated feedback signal i(t) to drive the acoustic structure 20. In general terms, the N-LACE provides gain and non-linearity, There are several ways in which this can be achieved, although as will be seen, some of these are more preferred than others since they provide for optimized performance of the acoustic oscillator device 10.

For ease of reference and to distinguish the preferred embodiment of a non linear amplitude control element (with particularly desirable characteristics to be detailed below) from the more generalised (arbitrary) non linear amplitude control element 90, the acronym “oN-LACE” (optimised non-linear amplitude control element) will be employed.

To summarize the properties of the optimal non-linear amplitude control element that is preferably employed in the acoustic oscillator device of embodiments of the present invention, it features three distinct signal regimes: a small-signal or quasi-linear regime (SS), a transitional signal regime (T) and a large-signal strongly non-linear regime (LS). In assessing the performance of a general non-linear amplitude control element there are four key parameters to consider:

1. The small-signal dynamic gain g_{dSS} at time t₁:

$${{g}_{dSS} ( {t}_{1} ) = \frac{\partial i ( {t}_{1} + τ )}{\partial v ( {t}_{1} )} \vert}_{SS}$$

where τ is a time delay characteristic of the input-out conversion in the N-LACE 90, which may or may not be frequency dependent.

2. The linearity of the small-signal quasi-linear regime.

3. The width of the transitional regime (T)—i.e. the range of input signal amplitudes for which the N-LACE response would be described as transitional.

4. The large-signal dynamic gain g_{dLS} at time t₁:

$${{g}_{dLS} ( {t}_{1} ) = \frac{\partial i ( {t}_{1} + τ )}{\partial v ( {t}_{1} )} \vert}_{LS}$$

where τ is as previously defined.

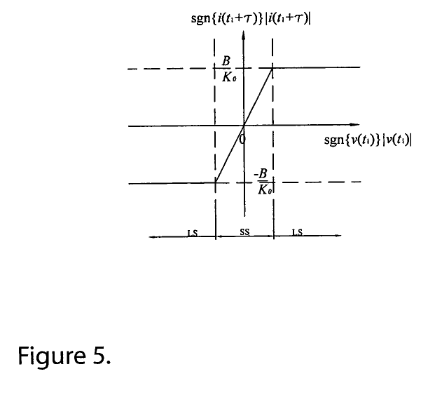

In the most preferred embodiment of the oN-LACE described in the context of the acoustic oscillator device, the small-signal dynamic gain (1) takes a large constant value which may or may not be dependent on the polarity of the input signal; the small-signal quasi-linear signal regime is approximately entirely linear (2), the transitional regime (T) is so narrow as to be negligible, and the large-signal (LS) dynamic gain is zero. FIG. 5 illustrates such an oN-LACE input-output characteristic for which the small-signal dynamic gain is K₀, independent of the polarity of the input signal ν(t) and the positive and negative amplitude thresholds have equal magnitude B. However, non-linear amplitude control elements with characteristics other than those shown in FIG. 5 are also contemplated.

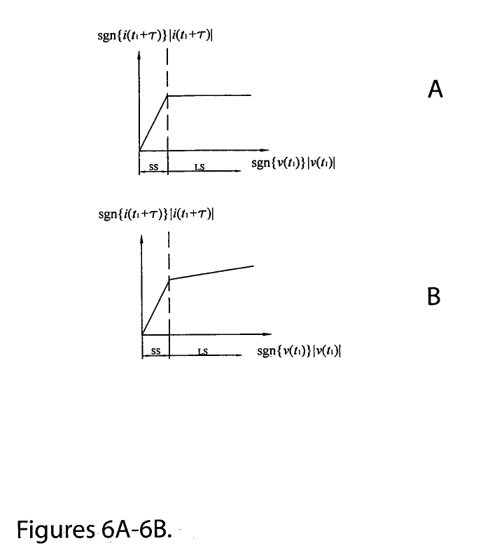

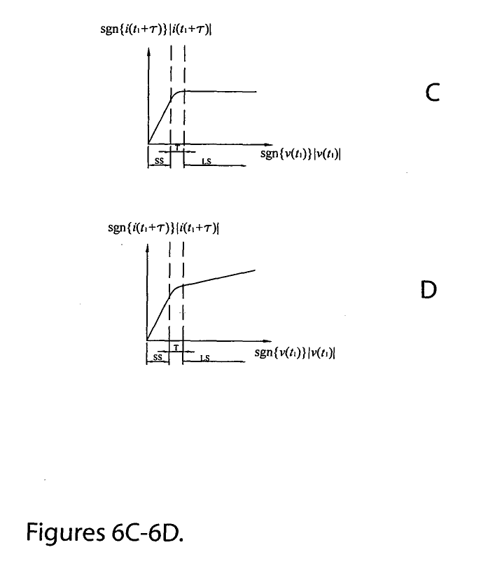

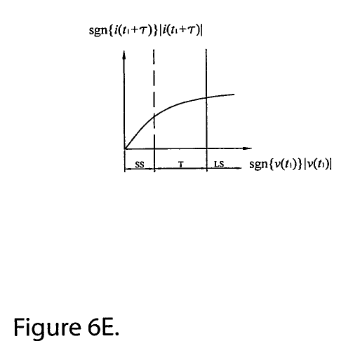

The family of non-linear amplitude control element input-output characteristics that fall within the oN-LACE definition are illustrated in FIGS. 6A-6D. FIGS. 6A-6D show only the oN-LACE input-output characteristic for positive values of instantaneous input signal ν(t₁). Note that the relative polarities of the oN-LACE input and output signals are arbitrarily defined. In general, the input-output characteristics may be symmetric in ν(t₁), anti-symmetric in ν(t₁), or entirely asymmetric in ν(t₁). FIG. 6A shows the ‘ideal’ input-output characteristic—this is entirely equivalent to the section of the graph of FIG. 5 for positive ν(t₁)—the small-signal quasi-linear signal regime (SS) is approximately entirely linear, the transitional regime (T) is so narrow as to be negligible, and the large-signal (LS) dynamic gain is zero. FIG. 6B shows an oN-LACE input-output characteristic, less favourable than the ideal characteristic of FIG. 6A though still representing an advantageous arrangement of oN-LACE suitable for use in the context of an acoustic oscillator device embodying the present invention. Here, the small-signal quasi-linear signal regime (SS) is—as in the ideal case—approximately entirely linear, and the transitional regime (T) is so narrow as to be negligible. However, there is a non-zero large-signal dynamic gain. Although non-zero, this large-signal dynamic gain is very much smaller than the small-signal dynamic gain i.e. g_{dSS}>>g_{dLS}.

FIG. 6C shows another oN-LACE input-output characteristic, which is likewise less favourable than the ideal characteristic of FIG. 6A but nonetheless still advantageous in the context of an acoustic oscillator device embodying the present invention. Here, the small-signal quasi-linear signal regime (SS) is—as in the ideal case—approximately entirely linear and the large-signal dynamic gain is approximately zero. However, there is a transitional regime (T) of finite width separating the small-signal quasi-linear (SS) and large-signal (LS) regimes. In this transitional region, the behaviour of the oN-LACE is neither quasi-linear nor strongly non-linear.

FIG. 6D shows yet another oN-LACE input-output characteristic, which is likewise less favourable than the ideal characteristic of FIG. 6A but nonetheless still advantageous in the context of an acoustic oscillator device embodying the present invention. Here, the small-signal quasi-linear signal regime (SS) is—as in the ideal case—approximately entirely linear. However, there is a transitional regime (T) of finite width separating the small-signal quasi-linear (SS) and large-signal (LS) regimes. In this transitional region, the behaviour of the oN-LACE is neither quasi-linear nor strongly non-linear. Additionally, there is a non-zero large-signal dynamic gain. Although non-zero, this large-signal dynamic gain is very much smaller than the small-signal dynamic gain i.e. g_{dSS}>>g_{dLS}.

Other oN-LACE input-output characteristics are possible that are less favourable than the ideal characteristic of FIG. 6A but still provide advantages in the context of an acoustic oscillator device embodying the present invention. For example, a slight non-linearity in the small-signal quasi-linear signal regime may be tolerated, as might a slight non-linearity in the large-signal regime. Combinations of slight non-idealities not explicitly described here are also permissible, for example: in a given oN-LACE characteristic there may be observed a slight non-linearity in the small-signal quasi-linear regime (SS), a narrow but non-negligible transitional region (T) and a small but non-zero large-signal dynamic gain g_{dLS} etc.

FIG. 6E shows a non-optimised N-LACE input-output characteristic which would not be preferred. Here, the small-signal (SS) regime differs considerably from the ideal, linear characteristic, the transitional regime (T) is wide such that one could not describe the transition from small-signal (SS) to large-signal (LS) regimes as ‘abrupt’ but might rather refer to it as ‘gradual’. The large-signal dynamic gain is also non-zero and the large-signal input-output response has some non-linearity. Such a non-optimised N-LACE characteristic would not support optimally rapid oscillator stabilization, frequency tracking (see description of “mode-tracking” applications later) or optimal immunity to noise/disturbance.

In the most general sense, there are two different ways in which non-linear amplitude control functionality may be achieved. The first type of non-linear amplitude controller incorporates a discrete active circuit element or an arrangement of discrete active circuit elements which provides a negative differential conductance or transconductance (i.e. gain) and a non-linearity. The non-linearity, and, in the majority of cases part or all of the gain, are each provided by a physical, non-linear process which is an inherent property of one or more of the circuit elements.

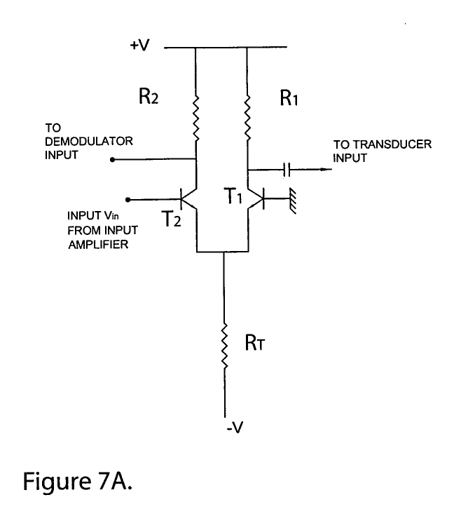

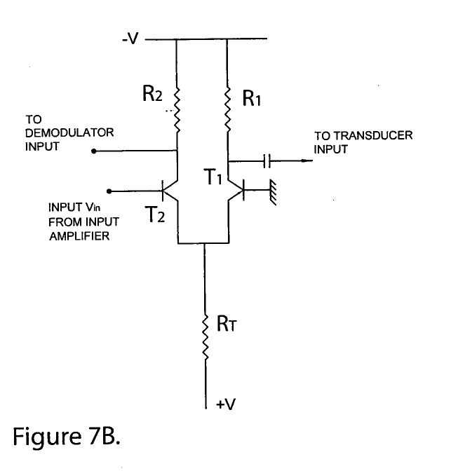

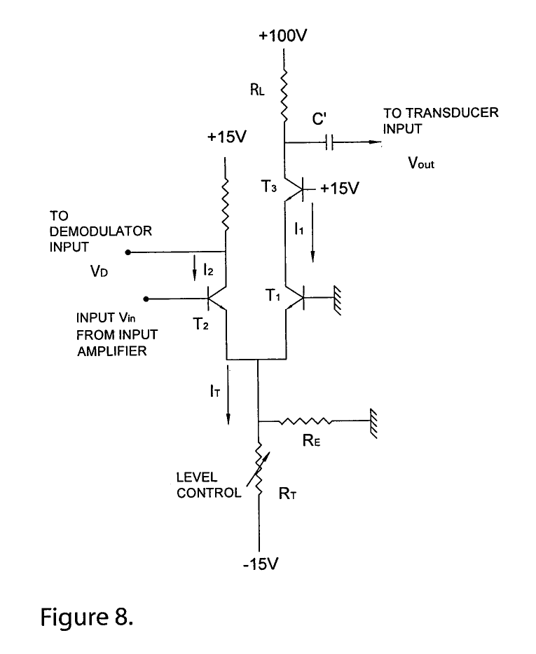

The functionality of the second type of non-linear amplitude controller is entirely equivalent to that of the first, but here, the non-linearity is provided not by an inherent physical non-linear process, but by deliberately arranging active elements so that the desired non-linear behaviour is promoted. One way of doing this is, for example, to exploit the gain saturation of an operational amplifier, or to use a transistor pair, as exemplified in FIGS. 7 and 8 (see below).

In both types of non-linear amplitude controller, the provision of gain and the provision of non-linearity may be considered as two independent functional requirements, which might accordingly be provided by two distinct functional blocks. In practice, the gain-non-linearity combination is often most readily achieved by exploiting the properties of a single collection of components. In any event, at least conceptually, the non-linearity may be considered as being superimposed on top of a linear gain characteristic, to create the desired set of input-output characteristics.

Considered in this way, the key function of the non-linearity is then to limit the maximum value of the gain (or the transconductance, or simply the output signal) of the overall amplitude regulator circuit. Overall, the intention is that the combination of the “gain” functionality and the “non-linear” functionality provides a unit which delivers a significant gain for small signals, and a constant magnitude output once the input exceeds a pre-determined threshold, as explained above.

FIGS. 7A and 7B show two simple exemplary circuits suitable for providing the desirable characteristics of an oN-LACE as outlined above. Each circuit is of the second type of non-linear amplitude control described above, that is, each provides a circuit induced non-linearity provided by a pair of bipolar junction transistors. In the case of the arrangement of FIG. 7A, the bipolar junction transistors are NPN, whereas in the case of FIG. 7B, PNP transistors are employed.

Looking first at FIG. 7A, a first embodiment of an oN-LACE is shown. The arrangement of FIG. 7 employs first and second NPN transistors T₁ and T₂, arranged as a long-tailed pair differential amplifier. The amplifier 70 (FIG. 3) provides an input voltage Vᵢₙ to the base of transistor T₂. The base of transistor T₁ is grounded. The collector of transistor T₁ is connected to a positive voltage rail +V via a first resistor R₁, and a collector of the second transistor T₂ is connected to the same positive voltage rail via a second resistor R₂. The emitters of each transistor T₁, T₂ are connected in common to a negative voltage rail −V via a tail resistor R_{T}.

The collector of the first transistor T₁ is capacitively coupled to the acoustic transmitter 60b. Thus the circuit of FIG. 7A provides an amplified and current regulated version of the circuit input to the base of transistor T₂ to drive the transducer 60b. In addition, this regulated output from the collector of the first transistor T₁ may be connected to the frequency counter 100 (FIG. 3) to provide a frequency output.

The collector of the second transistor T₂ provides a second circuit output to the demodulator 110 (see FIG. 3 again). This output from the collector of the second transistor T₂ is an AC signal at the frequency of the input signal Vᵢₙ with an amplitude proportional to that input voltage. This input level dependent signal, when demodulated by the demodulator 110, recovers a DC signal which is proportional to the input level. This DC signal may for example be employed to monitor changes in the quality factor (Q) of an acoustic resonance of an acoustic system. More specific details of this use of the demodulator output are set out below, where some examples of particular implementations of the acoustic oscillator device 10 embodying the present invention are described.

FIG. 7B shows an alternative circuit arrangement to that of FIG. 7A. The configuration is identical save that the transistors T₁ and T₂ are, in FIG. 7B, PNP transistors, and the voltage rails are thus reversed.

In each case of the circuit arrangements of FIGS. 7A and 7B, for small amplitudes of input, injecting a signal at the base of the second transistor T₂ results in a proportional current flow in the collector of the first transistor T₁ (and hence to the transducer via the capacitative coupling)—this is the linear regime of the oN-LACE and is provided via the small-signal “linear gain” regime of the transistor pair. Once the input reaches a certain threshold value, the first transistor T₁ is instantaneously driven “fully on”, and its collector current accordingly saturates at a predetermined value. This provides the “strongly non-linear” characteristic of the oN-LACE.

In each of the circuits of FIGS. 7A and 7B, the collector current of the second transistor T₂ varies with the voltage amplitude of the input signal for all values of input. Demodulation of this signal by the demodulator 110 provides, therefore, a means to monitor the amplitude of the input to the circuit, and, accordingly when the oscillator is operating in steady state, so that the transducer is driven at constant current, the loss characteristics of the acoustic system can likewise be monitored.

The convenient “dual” action of the circuits of FIGS. 7A and 7B (that is, the provision of an input-proportional current in the collector of the second transistor T₂, and a current with a non-linear dependence on input signal in the collector of the first transistor T₁) is by virtue of the broken symmetry of the common-emitter pair, i.e. the fact that the signal is supplied to the base of the second transistor T₂, whilst the base of the first transistor T₁ is grounded (earthed).

The abrupt transition between the linear and strongly non-linear regions, and the stability of the strongly non-linear region, are each achieved by a combination of:
(i) the speed and repeatability of response of the transistor pair T₁, T₂; and
(ii) the abrupt, non hysteretic transition between linear amplifying and “fully on” regimes for the two transistors; as well as
(iii) the pronounced asymmetry of the circuit.

Regarding (i) and (ii), for oN-LACE functionality, it is desirable that the phase shift associated with the signal conversion process of the oN-LACE is small and most preferably negligible. For a general non-linear amplitude control element to function correctly, it is necessary that the electronic blocks which provide the required gain and non-linearity deliver a phase shift which is less than and preferably much less than 45 degrees. Optimally (that is, in the case of the preferred oN-LACE non-linear amplitude control element), only a very small phase shift is tolerated, say, less than about 2 degrees. Such “fast conversion” functionality is delivered by the embodiments of FIGS. 7A and 7B, as well as the embodiment of FIG. 8 which will now be described.

FIG. 8 shows a combined, regulator detector circuit which also is capable of providing optimised non-linear amplitude control. The circuit of FIG. 8 incorporates a high voltage rail (in the embodiment of FIG. 8, a positive voltage rail of 100 volts is employed) together with level detection functions in conjunction with a transducer which is preferably a piezoelectric sound source. As with the arrangements of FIGS. 7A and 7B, the input to the circuit is Vᵢₙ, supplied from the amplifier 70 (FIG. 3) to the base of a second transistor T₂ of NPN type. The base of the first transistor T₁ is grounded.

As with the arrangements of FIGS. 7A and 7B, the transistors T₁ and T₂ constitute a differential amplifier configured as a long-tailed pair. Rather than a single, fixed resistive load connecting the emitters of the transistors to the negative voltage rail, however, the tail of the differential amplifier is formed of a resistive network comprising an emitter resistor R_{E} in combination with a variable tail resistor R_{T}. This combination of resistors, one of which is variable, acts as level control by adjusting the tail current I_{T}. The resistor R_{E} may be adjusted manually so as to set the maximum amplitude of the signal driving the transducer, or in more sophisticated arrangements, may be automatically adjusted by a subsidiary control loop. This automatic adjustment may for example be in response to a secondary feedback signal (for example a signal related to the progress of a process being carried out in the acoustic structure or another system (acoustic or otherwise) coupled thereto).

Unlike the arrangements of FIGS. 7A and 7B, however, the arrangement of FIG. 8 employs an active load which in the illustrated embodiment is a third NPN transistor T₃. This is connected so that the emitter of transistor T₃ is connected to the collector of the first transistor T₁. The base of the third transistor T₃ is connected to the positive voltage rail (plus 15 volts in the example of FIG. 8). The collector of the third transistor T₃ is connected, via a load resistor R_{L} to high voltage source feed, which is, as illustrated, for example 100 volts.

The circuit of FIG. 8 provides two outputs: a first is tapped off the collector of the second transistor T₂ and is a voltage V_{D} which is an AC signal at the frequency of the input signal Vᵢₙ with an amplitude proportional to that signal. This voltage V_{D} may be supplied to the demodulator 110 of FIG. 3 so as to recover a DC signal proportional to the input level. This DC signal might for example be used to monitor changes in the quality factor (Q) of an acoustic resonance of an acoustic system.

The second circuit output is labelled Vₒᵤₜ and is capacitively coupled from the collector of the third transistor acting as an active load to the differential amplifier of FIG. 8. Vₒᵤₜ is an amplified and current regulated version of the circuit input Vᵢₙ. Vₒᵤₜ drives the transducer 60b. This output signal Vₒᵤₜ may also be connected to the frequency counter 100 of FIG. 3, to provide a frequency output. Unlike the simple arrangement of FIGS. 7A and 7B, the circuit of FIG. 8 allows direct high-current drive to the transducer and is accordingly appropriate in applications of the acoustic oscillator requiring large amplitude pressure fields in the acoustic system, for example in acoustic filter or levitator applications (see later).

Certain intended implementations of the acoustic oscillator devices embodying the present invention involve “mode-tracking”. These implementations may involve either substantially propagating or substantially standing acoustic waves within the active region of the acoustic structure 20. The use of the terms “substantially propagating” or “substantially standing” is deliberate: as outlined in the foregoing, in the respective cases a small fraction of the total acoustic energy in the acoustic system is in the form of a standing pressure or propagating pressure wave respectively. In such mode-tracking implementations, a resonant mode of the acoustic structure 20, the frequency of which varies in time, defines the operating frequency of the oscillator and this mode is stabilized via a feedback signal generated from a raw receiver signal which is itself derived from a superposition of standing and propagating wave pressure variations at the acoustic receiver's location in the acoustic path. In such mode-tracking implementations, the oscillator controller 40 responds to discrete or continuous changes in the frequency corresponding to the resonant mode, (such as might be brought about by physical changes in the acoustic structure), bringing about a corresponding and approximately instantaneous discrete or continuous compensating variation in the operating frequency of the oscillator. For optimal mode-tracking performance, it is desirable that the amplitude control element within the oscillator controller is of the optimal type whose characteristics are described above and illustrated by example in FIGS. 7-8, so that the changes in the acoustic structure can be tracked rapidly and accurately by changes in the oscillator operating frequency. The oN-LACE introduced above offers superior performance over a general non-linear amplitude control element in mode-tracking:

Acoustic mode-tracking applications require that the preferred operating frequency ω₀ of the acoustic oscillator device 10 is a frequency corresponding to a resonant mode of the equivalent electrical system i.e.

$${ω}_{0} = \frac{1}{\sqrt{{L}_{E} {C}_{E}}} . \qquad ( 6 )$$

Where with reference to FIG. 4, L_{E} and C_{E} are an acoustic structure equivalent circuit inductance and capacitance, respectively.

Note that in acoustic mode-tracking implementations of the acoustic oscillator device, it is not necessarily the case that the acoustic structure has a single resonance frequency. In certain applications, the acoustic structure 20 may have a significant multiplicity of resonant modes, one of which it is desirable to select as the operating frequency of the acoustic oscillator device 10.

Appendix A derives the conditions for mode-tracking functionality in the general case of an acoustic oscillator device 10 with a non-linear amplitude controller, in terms of an equivalent circuit. In a general acoustic oscillator device 10 such as is illustrated in FIGS. 1A, 1B, 2A and 2B, incorporating a general N-LACE 90, small changes or fluctuations in the N-LACE equivalent circuit conductance (see Appendix A for further details), may have a profound effect on the amplitude of oscillation. As a result, such arrangements may be temperamental, and a subsidiary slow-acting amplitude control-loop may be required to promote reliable operation. This subsidiary control-loop is undesirable for several reasons—it adds complexity, it can lead to ground bounce (“motorboating” or “squegging”) and parasitic oscillation of the acoustic oscillator device 10 and it fundamentally limits the speed of the control-loop response to changing acoustic structure parameters.

In the case that the N-LACE 90 is of the preferred, optimal oN-LACE type described previously (in which there is as sharp as possible a transition between the quasi-linear (small-signal) and strongly non-linear (large-signal) regimes), in the steady-state oscillator regime the oN-LACE output has a particular power spectral density and an amplitude that takes a value that is generally approximately independent and preferably entirely independent of the instantaneous value of the input.

The steady-state output is independent of the actual negative conductance presented by the non-linearity and thus the parameters of the real devices that make up the oN-LACE. Predictable, robust performance is thus promoted without the need for any subsidiary slow-acting control-loop.

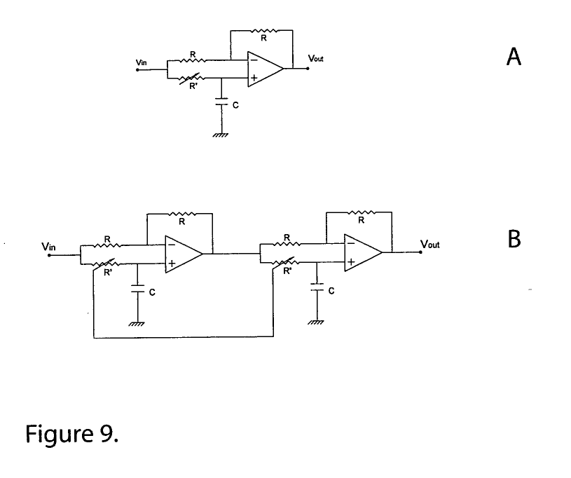

One possible example of a phase compensator 80 is shown in FIG. 9. It comprises two units (FIG. 9A) in series. Each unit has transfer function:

$$P ( jω ) = \frac{{V}_{out} ( jω )}{{V}_{in} ( jω )} = \frac{1 - jω {CR}^{′}}{1 + jω {CR}^{′}} .$$

The gain is unity at all frequencies, whilst the phase is given by

∠P(jω)=−2 arctan(ωCR′)

Thus, by cascading two such circuits and incorporating a ganged potentiometer, (for approximately constant ωC) the relative phase of the output and input may be varied between 0 degrees (R′=0) and 360 degrees (ωCR′>>1).

Some practical applications of an acoustic oscillator device 10 having the general characteristics outlined above in connection with FIGS. 1A, 1B, 2A and 2B, will now be described by way of example only. For ease of explanation, the types of device that may be implemented, can conveniently be divided into two classes: acoustic oscillator devices that employ substantially propagating waves, and acoustic oscillator devices that employ substantially standing waves. Some examples of acoustic oscillator devices employing substantially propagating waves will be presented first.

Devices using substantially propagating waves may be employed for example for the purposes of crack detection in solids or viscous gels etc. In such propagating wave implementations, the functional part of the acoustic structure 20 takes the form of a ‘transmission path’ comprising a ‘transmission medium’. For example, in an implementation of the acoustic oscillator device intended for the detection of cracks in a solid component, the functional part of the acoustic structure 20 would comprise a transmission path through the component or a region thereof. In substantially propagating wave implementations, an acoustic transmitter 60b (which may for example comprise or incorporate a sound source in the form of a piezoelectric acoustic transducer) excites the functional part of the acoustic structure 20 and an acoustic signal propagates along the transmission path to an acoustic receiver 60a. The receiver may or may not be may be distinct from the transmitter (see FIGS. 1A and 1B).

FIG. 10 shows a typical arrangement of an acoustic oscillator device 10 employing substantially propagating waves in solid structures. The device 10 comprises (see also FIGS. 1-3) a controller 40 including an amplifier 70, phase compensator 80 and oN-LACE 90a. The controller 40 provides an output 50b to an acoustic transmitter such as a piezoelectric transducer 60b mounted or affixed to the body of a material to be analysed. An acoustic receiver 60a is mounted elsewhere upon the material to be analysed, so that the material itself provides the acoustic system 30. The acoustic receiver 60a is connected back to the controller 40 via an input 50a so as to create a closed acoustic circuit.

In operation, a substantially propagating wave is launched into the material 30 by the transmitter 60b and after a short delay during which the oscillator stabilizes in a steady-state operating regime, a signal with standing and propagating wave components which is related to the acoustic properties of the transmission path through the material 30 is received by the receiver 60a. The amplitude of the received signal is proportional to the total acoustic loss in the transmission path, and is therefore sensitive to the total acoustic loss (which is the sum of dissipative and scattering loss components) associated with the acoustic path travelled. The phase of the received signal at the receiver 60a is proportional to the imaginary component of the acoustic impedance associated with the transmission path through the material 30. Thus, changes in the imaginary part of the acoustic impedance of the transmission path bring about changes in the operating frequency—that is, the “preferred operating frequency”—of the acoustic oscillator device 10. The controller 40 provides a continuous signal at a frequency which corresponds to that preferred operating frequency, the latter being related to the imaginary part of the acoustic impedance of the transmission path. Accordingly, by measuring this frequency, using the frequency counter 100 (see FIGS. 3 and 7 and 8 above) it is possible to recover information relating to this imaginary impedance component and/or indirectly, any external parameters such as temperature which might affect its value.

In acoustic oscillator devices 10 such as are exemplified in FIG. 10, and which permit testing or characterisation of bulk materials by employing a substantially propagating wave, it is also desirable to provide a means to monitor the losses (due to acoustic dissipation and/or scattering) in the transmission path provided by the sample material 30. This may be achieved via a comparison of the root mean square amplitude of the electrical signal which appears at the output of the controller 40 (which is constant in the steady state), with that of the received signal. Substantial change in these losses might signal the appearance of a crack or defect in the transmission path, or the onset of a physical fatigue or failure process.

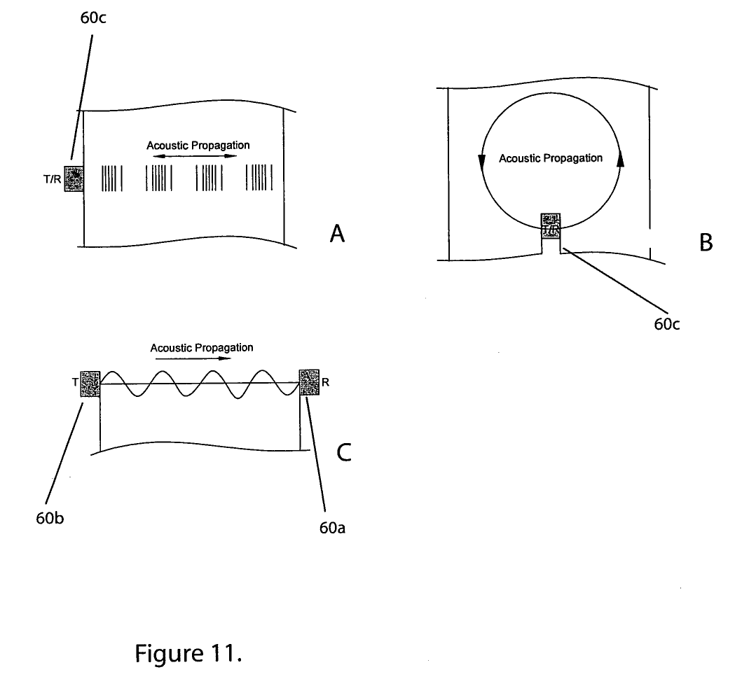

As an alternative to the arrangement of separate transmitter and receiver illustrated in FIG. 10, it is also possible to employ a combined transceiver. Arrangements incorporating such combined transmitter/receiver components 60c include ‘reflection mode’ systems in which an acoustic disturbance originating from a combined acoustic transmitter/receiver component 60c (e.g. a piezoelectric transducer) enters the transmission path, and its reflection, which arrives back at the transmitter/receiver component 60c after some time delay characteristic of the signal path, provides the raw received signal. This arrangement is illustrated schematically in FIG. 11A. Arrangements incorporating combined transmitter/receiver components 60c also include systems in which the transmission path is of a ‘loop type’ in which an acoustic disturbance originating from the transmitter/receiver component 60c propagates through the transmission medium along a closed transmission path before arriving back at the transmitter/receiver component 60c (FIG. 11B).

To summarize the propagating wave embodiments of the present invention, the operating frequency of such an implementation of the acoustic oscillator device is determined by the phase relationship between the transmitted and received signals. This operating frequency is thus affected by the acoustic properties of the transmission medium, most particularly it is related to or modified by the presence of any cracks and/or defects. Furthermore, the amplitude of the oscillator operation is affected by the loss characteristics of the transmission medium which may be deduced or monitored via the output of the demodulator 110 shown in FIGS. 3 and 10. The automatic frequency-adjusting characteristics of optimal substantially propagating wave mode-tracking implementations of the acoustic oscillator device-enable real-time crack and defect detection with a sensitivity and ease of implementation exceeding that of any currently available technology. Any type of sound source may be included in a substantially propagating wave implementation of the acoustic oscillator device. For the detection of cracks in the bulk of a material, a bulk acoustic wave (BAW) source is appropriate, (FIG. 10). For the detection of surface defects or features, a surface acoustic wave (SAW), or Rayleigh wave source may be employed (see FIG. 11C).

Some examples of substantially standing wave implementations of the acoustic oscillator device 10 are now set out. Such, devices employ acoustic waves in the ‘active region’ or ‘functional part’ of the acoustic structure 20 which are substantially acoustic standing waves with a small propagating wave component. A significant application of such substantially standing wave implementations of the invention is for the purposes of acoustic levitation and filtration. In view of the importance of such applications, a brief summary of the physics behind them will first be provided.

Acoustic filters and acoustic levitators exploit a second-order effect known as the acoustic radiation force. The acoustic radiation force causes small particles in suspension in the presence of an acoustic standing wave to migrate either towards or away from nodes in the pressure field. The direction of migration is dependent on the acoustic contrast between the particulate matter and the suspending medium.

The acoustic radiation force acting on a particle at a point Z₀ in an acoustic standing wave is given by,

$$\begin{matrix}{F}_{a} = - p ( {z}_{0} , t ) {( \frac{\partial p ( z , t )}{\partial z} )}_{{z}_{0}} V Φ ( β , ρ ) , & ( 7 ) \\ Φ ( β , ρ ) = \frac{{β}_{1}}{2} [ ( 1 - \frac{{β}_{2}}{{β}_{1}} ) + \frac{3 ( {ρ}_{2} - {ρ}_{1} )}{( 2 {ρ}_{2} + {ρ}_{1} )} ] , & ( 8 )\end{matrix}$$

where the subscripts 1 and 2 refer to the host medium and particle respectively and,

p(z,t) is the acoustic pressure distribution (a function of position z and time t),

p(z₀,t) is the pressure at point z₀,

V is the particle volume,

β is the adiabatic compressibility,

ρ is the density.

Φ(β,ρ) (8) is the acoustic contrast factor. For a given set of material properties, its sign determines the direction in which the radiation force (7) acts, and thus the direction of particle migration (i.e. towards or away from pressure nodes). Further details on the derivation of these expressions may be found in, for example, “On the acoustic radiation pressure on spheres” by King, Proc R. Soc. London Ser. A, 147:212-240, 1934 and in “Acoustic radiation pressure on a compressible sphere” by Yosioka et al, Acustica, 5:167-173, 1955.

Two materials M1 and M2 are said to have ‘like’ acoustic contrast if

sgn(Φ_{M1}Φ_{M2})=+1 (9a)

and ‘opposite’ acoustic contrast if the converse is true, i.e.

sgn(Φ_{M1}Φ_{M2})=−1. (9b)

Acoustic levitators are generally used to contain, suspend and/or manipulate substances, particles or objects etc. without physical contact. ‘Acoustic tweezers’ are a subset of acoustic levitator devices. Acoustic tweezers are used to capture and manipulate particles or objects without physical contact. Acoustic filters are typically used to isolate particulate matter in suspension. Up to two suspended particulate species may be independently separated. In such a system where two particulate species are independently isolated, it must be the case that the two species have opposite acoustic contrast (9b) with respect to the host (suspending medium). The ‘functional part’ or ‘active region’ of acoustic levitator and acoustic filter structures is a bounded region often termed an ‘acoustic cavity’ which is excited by a sound source. Functionality is dependent on the maintenance of a standing pressure wave in the active region which may be filled with a liquid, gaseous or solid medium.

Conventional (prior art) acoustic levitation and filtration devices typically operate in conjunction with a single externally driven sound source (generally a piezoelectric transducer). This source is separated from a fixed acoustic reflector by an ‘active region’ approximately an integer number of quarter wavelengths wide in the primary direction of acoustic propagation at the operating frequency of the device. Levitator and filter devices may have any geometry (planar, cylindrical, elliptical, etc.) and may operate in conjunction with one, two, or three dimensional acoustic waves. The acoustic structure comprising the active region, the boundaries of that active region, the sound source, the acoustic reflector and any other components is frequency selective, meaning that it responds preferentially or resonantly at one or more frequencies. Moreover, the frequencies at which the preferential or resonant response are observed correspond to frequencies at which standing pressure distributions are supported in the active region of the device. In order to excite a substantially standing wave in the active region (and thus achieve optimal levitation or filtration action), it is accordingly a requirement that the acoustic transducer is operated at a frequency which is substantially coincident with a resonant mode of the acoustic structure.

All conventional acoustic levitation and filter devices are essentially ‘driven oscillators’. In prior art arrangements, the active region of the device is driven via an external frequency source which, for the system to perform correctly, must be tuned to the required operating frequency. The acoustic oscillator device which embodies the present invention provides the basis for improved acoustic levitation and filter devices (and other related systems) which operate without an external frequency source. Furthermore, the acoustic oscillator device embodying this invention is inherently well suited to the requirements for mode-tracking control of acoustic levitator systems with high-Q active regions. Unlike the current state-of-the-art in acoustic levitator and filter control systems, the acoustic oscillator device embodying the present invention achieves real-time mode-tracking without any form of manual adjustment or electronic seek routine. Hardware requirements are minimal, and no stable variable frequency source or complex real-time processing logic is required. All electronics may be realized using inexpensive analogue electronic components. Moreover, unlike the current state-of-the-art filtration and levitation devices which operate in conjunction with a single standing wave mode, the filtration and levitation devices afforded by the acoustic oscillator device invention may be mode-selectable. Multi-mode stabilization is made possible by the presence of a deliberately engineered controlled propagating acoustic wave component in the predominantly ‘standing wave’ structure, the presence of a frequency dependent gain element in the feedback path of the oscillator and the fact that the effective acoustic path length in the acoustic structure is variable (see above).

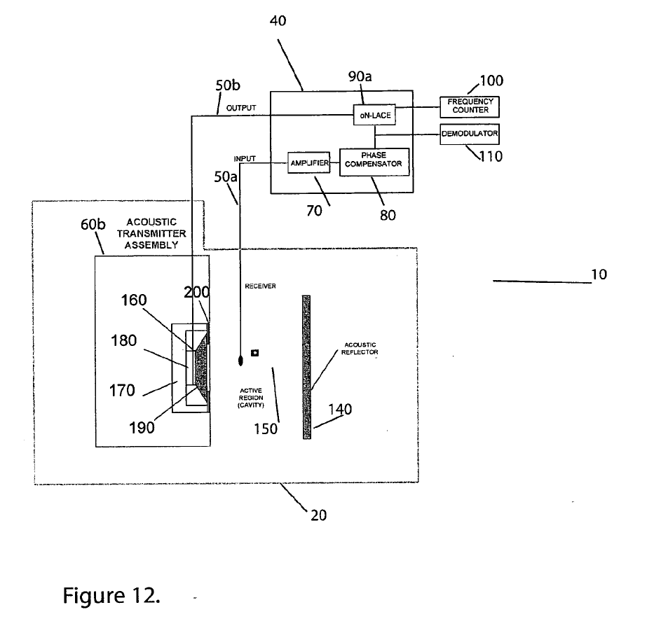

A first arrangement which employs a substantially standing wave is shown in FIG. 12, which illustrates an acoustic levitator. The components in FIG. 12 are based upon the general arrangement of FIGS. 1A and 3 in particular and like features are labelled with like reference numerals. The substantially standing wave implementation of an acoustic oscillator device 10 shown in FIG. 12 includes a controller 40 having an amplifier 70, a phase compensator 80 and an oN-LACE 90a as previously described, in communication with a frequency counter 100 and a demodulator 110. The details of these are as previously explained.

The controller 40 has an acoustic input 50a and output 50b which receive and transmit signals respectively to an acoustic structure shown generally at 20. The acoustic structure in this embodiment includes an acoustic receiver 60a which may for example take the form of a microphone, hydrophone, or piezoelectric transducer, arranged at any position between an acoustic transmitter 60b and an acoustic reflector 140 within an active region 150 which is approximately an integer number of quarter wavelengths wide in the primary direction of acoustic propagation at the operating frequency of the device. Typically in this embodiment, the acoustic transmitter 60b is distinct from the acoustic receiver 60a.

The acoustic transmitter 60b may be formed of an acoustic transducer 160 mounted within a transducer housing 170. The acoustic transducer 160 is captured between a transducer backing plate 180 and a transducer piston 190 which is held in place by a retaining ring 200. The acoustic transmitter 60b provides a source of planar, one dimensional acoustic waves.

The active region 150 of the device 10 of FIG. 12 is bounded so as to form a “levitation cell”. The levitation cell of FIG. 12, shown in schematic cross section, is of rectangular symmetry in the embodiment of that figure. Cells with more complex geometry such as cylindrical symmetry, or systems in which the levitation cell appears as an integral component of a “flow-through” or in-line device are also contemplated.

In operation of the arrangement of FIG. 12, a substantially standing wave is supported in the active region 150. The acoustic source provides plane wave. The levitation cell is typically filled with a liquid or gaseous (fluid) medium containing one or more acoustically contrasting elements, or a group of such acoustically contrasting elements, which it is desirable to levitate. Levitation functionality is achieved by virtue of the fact that the contrasting elements are driven by the acoustic radiation force either to nodes or antinodes in the substantially standing pressure field supported between the acoustic transmitter 60b and the acoustic reflector 140 in the levitation cell. The fluid medium and the suspended element or elements may be substantially static, or substantially dynamic and in either case the acoustic properties—that is, the density and/or compressibility of the host fluid and the contrasting elements, the number and number density of contrasting elements, the orientation of contrasting elements, the cross-sectional area of the contrasting elements, the volume of the contrasting elements, the temperature of the contrasting elements and so forth—may be constant or may evolve in time and may accordingly give rise to changes in the frequency corresponding to the desired operating mode of the acoustic structure.

As the frequency of the desired operating mode of the acoustic structure shifts, due to changing acoustic properties, the phase of the feedback signal delivered via the acoustic receiver component to the controller changes. These changes in phase bring about a corresponding and approximately instantaneous change in the operating frequency of the acoustic oscillator system, so that the operating frequency of the acoustic oscillator is always coincident with the frequency corresponding to the desired operating mode. Thus the acoustic oscillator controller 40 provides a signal at a frequency which corresponds to the resonance frequency of the acoustic structure, this resonance frequency being related to such quantities as are listed by way of example above. Accordingly, a measurement of this frequency, for example using the frequency counter 100, may be used to recover information regarding these quantities.

A quantitative measure of any changes in the quality factor (Q) of the acoustic resonance supported in the levitation cell, may also be extracted. When operating in the steady state regime, the root mean square amplitude of the electrical signal which appears at the output of the controller 40 is a constant, whilst the amplitude of the controller input signal is dependent upon the magnitude response of the acoustic system to this fixed root mean square controller output signal. It follows that the total signal gain provided between the controller input 50a and the controller output 50b varies with the Q of the acoustic system, specifically it is increased by a reduction in Q. Thus, the Q of the acoustic system may be monitored by comparing the root mean square value of the controller input signal with the root mean square value of the controller output signal.

The levitator shown in FIG. 12 may be designed to be operated at a single predetermined acoustic mode, or may be operable at two or more modes; mode switching is then possible and some techniques for doing that will be described later on.

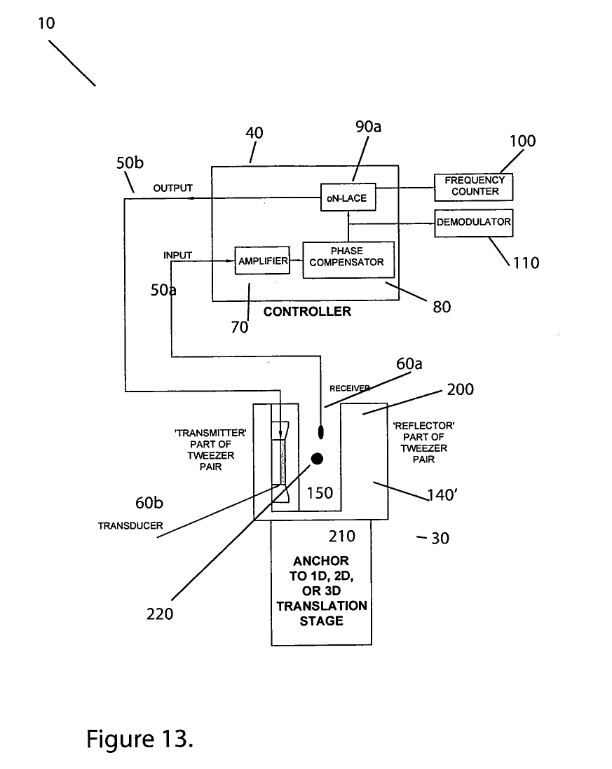

Turning now to FIG. 13, an embodiment of an acoustic oscillator device 10 acting as acoustic tweezers/manipulators is shown. Again, components common to previous figures are labelled with like reference numerals. The acoustic tweezers of FIG. 13 comprise a controller 40 having an amplifier 70, phase compensator 80 and oN-LACE 90a with frequency counter 100 and demodulator 110 connected. The output 50b of the controller 40 is connected to a transducer 60b mounted onto a support structure 200 which is generally “U” or “V” shaped and defines a bounded active region 150. An acoustic receiver 60a is positioned within the active region 150 defined by the support structure 200, and a wall of the support structure 200 generally opposed to the transducer 60b acts as a reflector 140′. The support structure 200 is itself mounted upon an anchor 210 which may allow one, two or three dimensional translation of the support structure.

In use, an item 220 to be manipulated without contact is inserted into the active region 150 through the opening in the generally “U” or “V” shaped support structure 200. A substantially standing wave is supported in the active region 150. Typically, the active region 150 is filled with a liquid or gaseous (fluid) medium containing one or more acoustically contrasting elements, or a group of such acoustically contrasting elements 220 to be captured, moved or manipulated. The item or items to be captured, moved or manipulated are driven by the acoustic radiation force either to nodes or antinodes in the substantially standing field supported between the transducer 60b and the reflector 140′ in the active region 150. The fluid medium and the suspended element 220 may be substantially static, or substantially dynamic and in either case the acoustic properties (density, compressibility of the host fluid and the element 220 to be captured/moved/manipulated, the number and number density of contrasting elements, the orientation of contrasting elements, the cross-sectional area of the contrasting elements, the volume of the contrasting elements, the temperature of the contrasting elements and so forth) may be constant or may evolve in time and may accordingly give rise to changes in the frequency corresponding to the desired operating mode of the acoustic structure. As the frequency of the desired operating mode of the acoustic structure shifts due to changing acoustic properties, the phase of the feedback signal delivered via the acoustic receiver 60a to the controller 40, changes. These changes in phase bring about a corresponding and approximately instantaneous change in the operating frequency of the acoustic oscillator system, so that the operating frequency of the acoustic oscillator device 10 is always coincident with the frequency corresponding to the designed operating mode. There is thus necessarily provided continuously by the acoustic oscillator controller 40, a signal at a frequency which corresponds to the resonance frequency of the acoustic structure, this resonance frequency being related to such quantities as listed above. Accordingly, a measurement of this frequency, for example via the frequency counter 100, may be used to recover information relating to these quantities.

A means to extract a quantitative measure of any changes in the quality factor Q of the acoustic resonance supported in the active region 150 is also provided. When operating in a steady state regime, the root mean square amplitude of the electrical signal which appears at the output 50b of the controller 40 is a constant, while the root mean square amplitude of the signal at the controller input 50a is dependent upon the magnitude response of the acoustic structure to this fixed root mean square controller output signal. It follows that, the total signal gain provided between the controller input 50a and controller output 50b varies with the Q of the acoustic system, specifically it is increased by a reduction in Q. Thus the Q of the acoustic system may be monitored by comparing the root mean square value of the signal at the controller input 50a with the root mean square value of the signal at the controller output 50b.

Although, in FIG. 13, a support structure 200 of generally rectangular section is shown, forming a “U” or “V” shaped structure, cells with more complex geometry, such as cylindrical symmetry, are also contemplated. Likewise, the acoustic tweezers of FIG. 13 may be designed to be operated either at a single, predetermined acoustic mode, or may be operable at two or more modes. In the latter case, mode switching may be accomplished in accordance with various techniques as will be described further below.

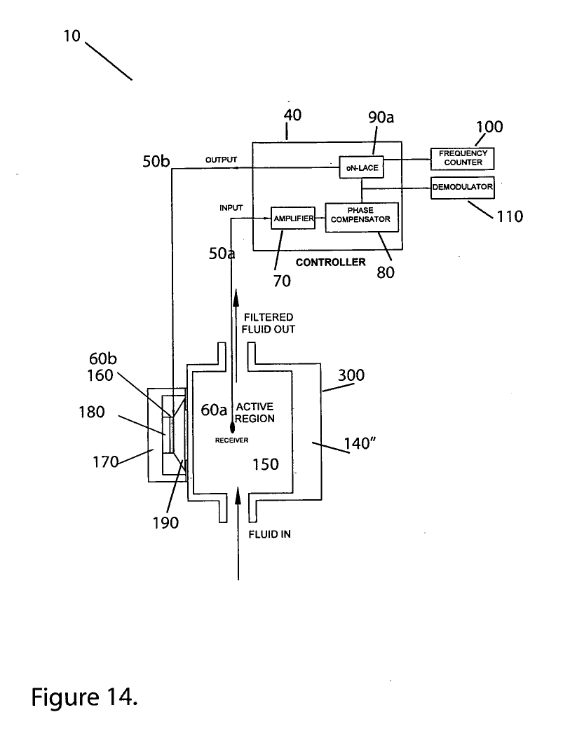

FIG. 14 shows still another implementation of an acoustic oscillator device 10 employing a substantially standing wave, this time for the purposes of acoustic filtration. Yet again, features common to earlier figures are labelled with like reference numerals.

The acoustic oscillator device 10 of FIG. 14 employs a controller 40 having an amplifier 70, phase compensator 80 and oN-LACE 90a, again in communication with a frequency counter 100 and demodulator 110. The output 50b of the controller 40 is connected to an acoustic transmitter 60b which may be formed of an acoustic transducer 160 mounted within a transducer housing 170. The acoustic transducer 160 is captured between a transducer backing plate 180 and a transducer piston 190. The transducer housing 170 is affixed to a side wall of a filtration channel 300 which is of generally square or rectangular section in the embodiment of FIG. 14, but has openings within upper and lower walls of the filtration channel 300 to define an inlet and outlet for fluid flow. The transducer housing 170 is mounted upon a side wall of the filtration channel, transverse through the direction of flow of fluid from the fluid inlet to the fluid outlet. A further side wall of the filtration channel 300, opposite the acoustic transmitter 60b, acts as a reflector 140″. An acoustic receiver 60a, which may for example be a microphone or hydrophone, is suspended between the acoustic transmitter 60b and the wall of the filtration channel 300 forming the reflector 140″.

In operation, a substantially standing wave is established between the transducer 60b and the opposing wall of the filtration channel 300 which forms the reflector 140″. The active region 150 is filled with a liquid or gaseous (fluid) medium (although, systems incorporating quasi-solid media such as foams or powders are also feasible) containing one or more suspended particulate components which it is desirable to separate or isolate. Filtration is achieved by virtue of the fact that the suspended particular components are driven by the acoustic radiation force either to nodes or antinodes in the standing pressure field depending upon their acoustic contrast with respect to the suspending medium. The fluid medium may be substantially static, or substantially flowing and in either case the acoustic properties (that is, the density and/or compressibility of the suspending fluid and the particulate components, the particulate concentration, particulate size, particulate distribution and so forth) may be static, or may evolve in time giving rise to changes in the frequency corresponding to the desired operating mode of the acoustic structure. As the frequency of the desired operating mode of the acoustic structure shifts due to changing acoustic properties, the phase of the feedback signal delivered via the acoustic receiver component 60a to the controller 40 changes. These changes in phase bring about a corresponding and approximately instantaneous change in the operating frequency of the acoustic oscillator device 10 so that the operating frequency of the acoustic oscillator device 10 is always coincident with the frequency corresponding to the desired operating mode. The acoustic oscillator controller 40 thus continuously provides a signal at a frequency which corresponds to the resonance frequency of the acoustic structure 20, this resonance frequency being related to such quantities as temperature, particulate concentration, fluid viscosity, fluid velocity and so forth. Accordingly, a measurement of this frequency, for example using the frequency counter 100, may be used to recover information relating to these quantities. A means to extract a quantitative measure of any changes in the quality factor Q of the acoustic resonance supported by the filtration channel 300 may also be provided. When operating in a steady state regime, the root mean square amplitude of the electrical signal which appears at the output of the controller 40 is a constant, whilst the root mean square amplitude of the signal at the controller input 50a is dependent on the magnitude response of the acoustic system to this fixed root mean square controller output signal. It follows that the total signal gain provided between the input of the controller 40 and the controller output 50b varies with the Q of the acoustic system, specifically it is increased by a reduction in Q. Thus the Q of the acoustic system may be monitored by comparing the root mean square value of the signal at the controller input 50a with the root mean square value of the signal controller output 50b.

Although the filtration channel shown in FIG. 14 is shown with rectangular symmetry, in which the axis of acoustic propagation is perpendicular to the direction of fluid flow, cells with more complex geometry may be employed. For example, a filtration channel having cylindrical symmetry may be employed, or a system may be constructed in which the acoustic filtration channel 300 appears as an integral component of a more complex fluid flow device. Square and rectangular systems typically but not exclusively operate in conjunction with plane wave sources and the acoustic mode structure of such systems is accordingly described by a superposition of two sets of orthogonal one-dimensional modes. The acoustic propagation in cylindrical systems, by contrast, may be either plane or cylindrically symmetric; in the latter case, the characteristic modes of the acoustic system are Bessel functions. For the propagation of plane acoustic waves within a cylindrically symmetric system, the dimensions of the cylindrical system both in the direction of the acoustic transmission path and in the two directions perpendicular to that path are preferably large compared with the acoustic wavelength.

Additional fluid or particulate inflows and outflows to the filtration channel 300 might be incorporated, such as for example might be used to remove particulate species isolated by the acoustic field (a particulate exhaust). Likewise, the filter may be designed to be operated at a single predetermined acoustic mode, or may be operable at two or more modes; mode switching may be achieved in accordance with techniques to be described next.

The acoustic oscillator devices described herein typically feature not one, but a number of possible operating frequencies or operating ‘modes’. Thus, modal selectivity—the ability to select a single operating mode which is favoured over all others—is desirable. In certain implementations of the acoustic oscillator device it is desirable to operate the oscillator at a frequency which corresponds to a single, known operating mode of the system. Additionally, the ability to switch between possible operating modes—i.e. to select different operating modes of the device according to the application—may be beneficial. Mode ‘switching’ functionality is a particular advantageous feature of certain implementations of the acoustic oscillator device embodying the present invention.

In substantially standing wave implementations of the acoustic oscillator device, the acoustic structure typically exhibits a fundamental resonance frequency corresponding to the lowest frequency substantially standing wave mode supported by the active region of the structure, and a series of harmonics. In such substantially standing wave implementations it is generally desirable to excite a single oscillator mode—i.e. to suppress oscillations at all but one of the frequencies at which the acoustic structure system responds resonantly; this process may be referred to as “enabling a strongly-preferred mode”. In such a substantially standing wave implementation, modal selectivity allows for the standing wave pattern to be manipulated and thus—in levitator and filter applications—for the distributions and/or positions of suspended particulates or objects to be changed.

Mode switching in a substantially propagating wave implementation of the technology might be of interest in materials characterization applications if, for example, it is desirable to obtain information about the variation, with frequency, of the acoustic properties of a test item.

In the context of the ‘mode switchable’ acoustic oscillator devices described above, selection and stabilization of multiple modes is made possible by the fact that the effective acoustic path length within the device is variable (see earlier description), that a frequency dependent gain element with a fixed or variable electronic transfer function exists within the oscillator control-loop and that in any implementation of the acoustic oscillator, the raw pressure signal received by the receiver component from which the feedback signal is generated has standing wave and propagating wave components. In a given general implementation of the acoustic oscillator device invention, one or more of three mode selection techniques may be employed.

The first technique for mode selection and stabilization employs frequency dependent gain. This technique involves the use of an appropriately designed frequency dependent gain element in the oscillator controller 40 or in an additional signal processing element. In general, though not necessarily, such a frequency dependent gain operates in the electrical analogue domain and may for example, take the form of an active or passive low-pass, high-pass, bandpass or notch filter.

A second technique for mode selection and stabilization employs hardware design and arrangement; here implementation involves designing the acoustic structure 20 particular to an acoustic oscillator device 10 such that one or more desired operable modes are extant whilst others are precluded. The mechanism by which unwanted modes are precluded or accessed is either or a combination of sound source, receiver or acoustic system design, placement or motion.

A third method of mode selection and stabilization uses frequency dependent phase shift. This method is enabled by the fact that the phase information returned to the acoustic oscillator device controller 40 by the acoustic receiver 60a is dependent upon both its position along the acoustic path in the acoustic structure 20 and its frequency of operation. Thus a combination of the positioning (or variable positioning) of the receiver 60a, and variable phase input from a phase compensator component 80 and a frequency dependent gain element may be used to select and stabilize a desired operating mode.

The foregoing has considered devices having a single sound source and receiver (either combined or separate). Systems incorporating multiple sound sources and receivers may also be constructed, as well as systems incorporating sound sources and receivers with time dependent positions.

Various further implementations of the device 10 in accordance with the present invention may be contemplated. Turning first to the subset of acoustic oscillator devices 10 that employ a substantially propagating wave, these have applications in non-destructive, non-invasive materials and component testing. As outlined above, substantially standing wave implementations have significant applications in acoustic levitation and filtration and related devices. In particular, the automatic frequency-adjusting mode-tracking behaviour of certain optimal, substantially standing wave implementations of the acoustic oscillator device 10 in accordance with the present invention circumvent certain practical barriers associated with the realization of filtration, levitation and related instruments capable of operating in applications where there is significant temporal variation in the acoustic properties of the functional acoustic part of the device. Such applications include; the localization and entrapment of particulates or gas bubbles in lubrication, hydraulic and fuel systems in the motor and aerospace sectors, micro-bubble and particulate manipulation in molten metal forming, biological sample preparation, filtration applications in the wine-making, drink and food industries, the curing or processing of industrial plastics and foams and certain clinical applications. Specifically, substantially standing wave implementations of the acoustic oscillator device 10 are envisaged to provide the basis for acoustic filtration systems suitable for the separation of Lipid Microemboli (LME) from flowing blood in cardiopulmonary bypass circuits. LME are small droplets of fat (typically 5 to 50 μm in diameter) which contaminate cardiopulmonary bypass circuits via drain-off from carditomy suction devices. Recently, LME have been strongly implicated in post-surgical cerebral dysfunction. At present, scavenged pericardial suction blood is ‘washed’ using a centrifugal cell-saver device, and/or filtered, prior to being returned to the patient. Whilst this centrifugal washing is a highly efficient means of LME removal, it is an off-line technique and as such, cannot be used to deal with those microemboli that are entrained in the flowing bypass stream. Furthermore, the process depletes blood of important clotting factors and may activate an inflammatory cascade. Physical filtration systems are not an effective remedy to this separation problem, and can introduce further complications: filter fibres tend to retain fat-droplets which are later released into the filtrate. Fat-retention may be inhibited by lowering the blood temperature, but this leads to filter clogging and haemolysis. The acoustic contrast factors of microemboli and red blood cells in a plasma suspension differ in sign, thus acoustic filtration has been identified as a candidate alternative. The technique potentially circumvents the difficulties described, and has been shown to be harmless to vital blood components. However, the current state-of-the-art in acoustic filtration devices is insufficiently scalable or robust to provide a practical acoustic filtration solution. Thus there is provided by the acoustic oscillator device of embodiments of the present invention a potential platform technology for a range of novel acoustic filtration devices for clinical flow-filtration applications.

Acoustic levitators incorporating the self-oscillating acoustic oscillator device technology may used to suspend volatile or combusting droplets, reacting mixtures, biological cultures and cells free to interact away from boundaries, or asymmetrical moving objects (for example bubble or foam clusters or living organisms). Additionally, acoustic tweezers may be realized using substantially standing wave implementations of the acoustic oscillator device 10 see FIG. 13 and its accompanying description. Such acoustic tweezers and devices comprising acoustic tweezers and other functional components—for example positioning stages and microscopy equipment—may be macro, micro or nanoscale and may be used for example to manipulate small particles or large biological molecules or populations thereof. Both the levitator and filter technologies described above may find uses in nanotech and biotech sectors for example: in the manipulation, separation, isolation and/or processing of nanoscale particles, systems of particles or nanoscale devices and in the manipulation, separation, isolation and/or processing of biological particles (e.g. protein molecules). In this context, selective ‘acoustic labelling’ of mixed particulate species (which may or may not be biological in origin) may be exploited. For example, in a two component mixture of particles with like acoustic contrast factor with respect to their host solution but different chemical properties, an additive with an opposite acoustic contrast factor with respect to the host may be bound to one species, allowing separation of the two using an acoustic filtration device based on the acoustic oscillator device technology.

Additionally, the acoustic oscillator device of embodiments of the present invention provides the basis for a range of diagnostic substantially standing wave mode-tracking acoustic devices which may or may not incorporate a primary levitation or filtration function. The operating frequency of such devices—which corresponds to a resonant mode of the active part of the particular acoustic structure—and the quality factor of that resonant mode together provide an indication of acoustic properties of the active part of the acoustic structure.

Mode selection as outlined above may be exploited to realize substantially propagating or standing wave mode-tracking implementations of the acoustic oscillator device with the capacity to operate at frequencies co-incident with two or more resonant modes of a multi-modal distributed-parameter acoustic structure. Simultaneous independent control of two or more resonant modes of such a multi-modal distributed-parameter acoustic structure requires separate acoustic oscillator device controllers for each mode.

The acoustic oscillator devices described may be realized in conjunction with a wide range of distributed-parameter acoustic structure geometries. These include distributed-parameter acoustic structure with for example rectangular, circular, cylindrical, spherical or elliptical symmetry. Multi-axial substantially propagating or substantially standing wave implementations of the acoustic oscillator device are possible e.g. a tri-axial acoustic levitator. The acoustic oscillator devices described by the present invention may be operated in conjunction with any type of acoustic source (piezoceramic transducer, membrane, piston, shear-mode etc.) within any accessible range of acoustic frequencies (low-frequency, audio, ultrasonic, UHF etc.)

Although a specific embodiment of the present invention has been described, it is to be understood that various modifications and improvements could be contemplated by the skilled person.

### Appendix A: Acoustic Oscillator.

1 Description of the non-linear amplitude control element (N-LACE)

In this Section we offer a detailed description of the non-linear amplitude control element (N-LACE) integral to the acoustic oscillator invention.

For the purposes of analysis, it is useful to consider N-LACE functionality separately from that of the rest of the controller. The model of FIG. A1A is equivalent to that of FIG. 4C (reproduced as FIG. A1B) but here, the instrument controller is represented by two complex, frequency dependent elements: G_{NL} representing the N-LACE and H which accounts for the remainder of the functional elements of the acoustic oscillator controller. In this model, H is assumed to be entirely linear in v₁(t) thus, with reference to the figure, the input to the N-LACE v(t), is a linear function of v₁(t) whilst the N-LACE output i(t) is a non-linear function of v(t).

1.1 Functional overview of the N-LACE

The non-linear amplitude control element (N-LACE) provides an amplitude regulated feedback signal i(t) to drive the acoustic structure.

The output of the acoustic structure—V₁(t) (FIG. A1A)—is a continuous periodic energy signal, with a spectral component s(t) at the operating frequency φ₀ of the acoustic oscillator. The time-period T characteristic of s(t) is given accordingly by:

$$T = \frac{2 π}{{ω}_{0}} . \qquad ( A 1 )$$

The signal s(t) is isolated from v₁(t) (e.g. by filtering and subsequent phase-compensation) so that the signal arriving at the input to the N-LACE is of the form

v(t)=AS(t—τ₁), (A2)

For the purposes of analysis, it is useful to consider N-LACE functionality where A is a constant and τ₁ a time-constant to account for inherent or imposed time delay and/or phase shift in the signal path. The feedback signal generated by the N-LACE in response to v(t) is of the form:

i(t)=α_{NL}(v(t-τ₂)) (A3)

where

τ₂=τ₁+τ. (A4)

and τ is a time delay characteristic of the input-output conversion in the N-LACE which may or may not be frequency dependent. The instantaneous dynamic gain of the N-LACE is defined for any instantaneous signal input V(t₁)

$${g}_{d} ( {t}_{1} ) = \frac{\partial i ( {t}_{1} + τ )}{\partial v ( {t}_{1} )} . \qquad ( A5 )$$

It should be noted that the ‘dynamic gain’ (defined here in conjunction with (A5) and used subsequently) is not a ‘gain’ in the conventional dimensionless sense, but a transconductance.

In the most general implementation of the acoustic oscillator, the function α_{NL}(v(t)) which describes the N-LACE is an arbitrary non-linear function. However, in a particular preferred embodiment of the N-LACE, the function α_{NL}(v(t)) has particular advantageous characteristics. From henceforth, a non-linear amplitude control element with such particular advantageous characteristics will be referred to as an optimal non-linear amplitude control element or oN-LACE.

1.2 Optimal N-LACE characteristics

In this Section we describe the characteristics of an optimal non-linear amplitude control (oN-LACE) which features in certain preferred embodiments of the acoustic oscillator. When at time t₁ the instantaneous amplitude of the oN-LACE input signal v(t₁) is between certain preset fixed ‘positive’ and ‘negative’ thresholds the corresponding output i(t₁+τ) of the oN-LACE is approximately equivalent to a linear amplifier with a gain that is—in the most general case—dependent on the polarity of the signal. For a given oN-LACE implementation, the ‘positive’ and ‘negative’ thresholds are respectively

$$+ \frac{{B}_{1}}{{K}_{01}}$$

and

$$- \frac{{B}_{2}}{{K}_{02}}$$

where B₁, B₂ are any real, non-negative integers (so long as in a given realization either B₁ or B₂ is non-zero) and K₀₁ and K₀₂ 0J are real non-zero positive integers equal to the small-signal (SS) dynamic gains for positive and negative v(t) respectively:

$$\begin{matrix}{{g}_{{dSS}^{+}} ( {t}_{1} ) = {K}_{01} = \frac{\partial i ( {t}_{1} + τ )}{\partial v ( {t}_{1} )} \vert}_{{SS}^{+}} , & ( A6a ) \\ {{g}_{{dSS}^{-}} ( {t}_{1} ) = {K}_{02} = \frac{\partial i ( {t}_{1} + τ )}{\partial v ( {t}_{1} )} \vert}_{{SS}^{-}} . & ( A6b )\end{matrix}$$

In this signal regime, the output of the oN-LACE is described by:

i(t₁+τ)=K₀₁ v(t₁) for sgn {v(t₁)}=1 i(t₁+τ)=K_{02 v(t}₁) for sgn {v(t₁)}=−1 (A7)

Note that the relative polarities of the oN-LACE input and output signals are arbitrarily defined. In the most preferred embodiment of the oN-LACE. at least one of K₀₁ and K₀₂ is a large, positive, real constant. Equation (A7) describes the ‘quasi-linear amplification regime’ or ‘small-signal amplification regime’ of the oN-LACE.

If at time t₁, the instantaneous amplitude of v(t₁) is positive and its magnitude equals or exceeds the threshold

$$\frac{{B}_{1}}{{K}_{01}}$$

and/or the instantaneous amplitude of v(t₁) is negative and its magnitude equals or exceeds the threshold

$$\frac{{B}_{2}}{{K}_{02}}$$

, the oN-LACE operates in a ‘strongly non-linear’ or ‘large-signal’ regime. In the most preferred embodiment of the oN-LACE, the dynamic gain in the large-signal (LS) regime is zero regardless of the polarity of the signal v(t₁):

$${{g}_{dLS} ( {t}_{1} ) = \frac{\partial i ( {t}_{1} + τ )}{\partial v ( {t}_{1} )} \vert}_{LS} = 0. \qquad ( A8a )$$

In a general embodiment of the oN-LACE. the large-signal dynamic gain g_{dLS} (t) is approximately zero regardless of the polarity of the signal v(t₁) i.e:

$${{g}_{dLS} ( {t}_{1} ) = \frac{\partial i ( {t}_{1} + τ )}{\partial v ( {t}_{1} )} \vert}_{LS} \approx 0. \qquad ( A8b )$$

The most preferred embodiment of the optimal non-linear amplitude control element features a large-signal regime in which the amplitude of the oN-LACE output i(t₁+τ) takes a constant value +B₁ if at time t₁ the instantaneous amplitude of v(t₁) is positive, and a constant value −B₂ if the converse is true. This behaviour is summarized by;

$$if \vert v ( {t}_{1} ) \vert \geq \frac{{B}_{1}}{{K}_{01}} and sgn [ v ( {t}_{1} ) ] = 1 , \vert i ( {t}_{1} + τ ) \vert = + {B}_{1} , \\ whilst if \vert v ( {t}_{1} ) \vert \geq \frac{{B}_{2}}{{K}_{02}} and sgn [ v ( {t}_{1} ) ] = - 1 , \\ \vert i ( {t}_{1} + τ ) \vert = - {B}_{2} . \qquad ( A9 )$$

In the special case that B₁=B₂=B and K₀₁=K₀₂=K₀, (A9) becomes:

$$if \vert v ( {t}_{1} ) \vert \geq \frac{B}{{K}_{0}} and sgn [ v ( {t}_{1} ) ] = 1 , \vert i ( {t}_{1} + τ ) \vert = + B , \\ whilst if \vert v ( {t}_{1} ) \vert \geq \frac{B}{{K}_{0}} and sgn [ v ( {t}_{1} ) ] = - 1 , \vert i ( {t}_{1} + τ ) \vert = - B \qquad ( A10 )$$

and a symmetrical oN-LACE input signal v(t₁) results in a symmetrical output function i(t₁+τ)

Between the quasi-linear and strongly non-linear signal regimes of the oN-LACE there is a ‘transitional’ signal region or ‘transition region’ (T). In this region, the behaviour of the non-linear amplitude control element is neither quasi-linear nor strongly non-linear. In the most preferred embodiment of the oN-LACE the transition region is negligibly wide.

FIG. 5 illustrates the most preferred input-output characteristics of the oN-LACE for the case that: B₁B₂=B and K₀₁=K₀₂=K₀ (A10); there is no transitional (T) signal regime; the small-signal (SS) dynamic gain is independent of |v(t₁)| and the large-signal (LS) dynamic gain is zero (A8a)

Three key features of the oN-LACE are: Feature 1: a sharp transition between the quasi-linear (small-signal) and strongly non-linear (large-signal) regimes effected by the instantaneous signal magnitude |v(t₁)| exceeding a pre-determined threshold, the value of which may or may not be dependent on the polarity of the signal (c.f. (A9), (A10)); Feature 2: a narrow and preferably negligibly wide transitional signal regime; Feature 3: approximately instantaneous transition between quasi-linear and strongly non-linear regimes. Feature 3 is equivalent to the oN-LACE having capacity to respond to change in the amplitude (and frequency) of the instantaneous input signal v(t₁) on a timescale typically significantly shorter than the characteristic signal period T i.e the oN-LACE has a certain amplitude temporal resolution Aτ<<T. Furthermore, with a particular implementation of the oN-LACE described in the context of the present invention it may be arranged that the instantaneous amplitude of the oN-LACE output i(t₁) corresponds approximately instantaneously to that of the input i.e. if desirable, it may be arranged that the time-constant τ defined in (A4) is negligibly small. Alternatively and more generally, the oN-LACE is designed such that a certain known time-delay τ (which may or may not be frequency dependent) exists between oN-LACE input and corresponding output; in such a system an oN-LACE input v(t₁) gives rise to an output i(t₁+τ) with amplitude temporal resolution Δτ independent of τ. It is an important and particular feature of the present invention that the amplitude control achieved via the oN-LACE is not of a slow-acting ‘averaging’ type. Moreover, changes in the centre frequency or dominant frequency component of the input signal v(t₁) may be resolved on a time-scale comparable with the amplitude temporal resolution Δτ; i.e. the frequency content of a general output signal i(t₁+τ) corresponds to the instantaneous frequency content of the input v(t₁).

1.3 oN-LACE signal characteristics: symmetrical input signal

In this Section we discuss the input-output signal characteristics of the oN-LACE for the special case that the input is a symmetrical, sinusoidal waveform with frequency φ₀ and period of oscillation T (A1). Asymmetrical input signals are described in Section 1.4. In accordance wrth the description at the beginning of Section 1.1 and with reference to (A3) and (A4) we assume that the oN-LACE input signal is a time-shifted, linearly amplified denvative of an electrical signal s(t): a monochromatic signal at the effective resonance frequency of the oscillator φ_{0.} For clarity in this Section we reference all signals relative to time t defined by s(t):

s(t)=αsinφ₀t (A11a)

v(t+τ₁)=A sinφ₀t (A11b)

The oN-LACE input signal (A11b) is depicted in FIG. A2A. In the analysis that follows, we consider the particular case that the positive and negative amplitude thresholds characteristic of the oN-LACE have equal magnitude (i.e. (A10) holds), that the small-signal regime is characterized by a certain constant dynamic gain K₀ independent of the polarity of the signal v(t+τ₁), that the large-signal dynamic gain is zero and that there is no transitional signal regime.

In the quasi-linear amplification regime, the output signal from the oN-LACE is given by a time-shifted, linearly amplified version of the input signal:

i(t+τ₂)=AK₀sinφ₀t (A12)

FIG. A2B shows the output i(t+τ₂) of the non-linear amplitude control element for the case that for the entire period T of the signal v(T+τ₁)

$$\vert v ( t + {t}_{1} ) \vert \leq \frac{B}{{K}_{0}} ,$$

i.e. the oN-LACE operates continuously in the quasi-linear amplification regime.

FIG. A2C shows the output from the non-linear control element i(t+τ₂) for the case that during around half of the period of the input signal T,

$$\vert v ( t + {τ}_{1} ) \vert > \frac{B}{{K}_{0}} .$$

The function of the oN-LACE is to amplify the received monochromatic energy signal v(t+τ₁) at φ₀ (in general an amplified, time-shifted, phase compensated version of a raw electrical signal s(t)), and redistribute its RMS power over harmonics of the signal frequency φ₀. In what follows we compare the Fourier series describing oN-LACE input and output signals and give an insight into how the distribution of power is affected by the amplitude A of the input signal v(t+τ₁). We derive the Fourier representation of the output signal of the oN-LACE corresponding to a symmetrical sinusoidal input of general amplitude A assuming oN-LACE characteristics as described above.

FIG. A3 shows a single positive half-cycle of v(t+τ₁) and, superimposed (bold), a single positive-half cycle of a corresponding oN-LACE output i(t+τ₂). The limiting values of the oN-LACE output, ±B are indicated. We assume that the ratio A/B is such that for a fraction 1-α of a quarter-cycle

$$\vert v ( t + {τ}_{1} ) \vert \geq \frac{B}{{K}_{0}}$$

i.e. for the positive half-cycle

$$\vert v ( t + {τ}_{1} ) \vert \geq \frac{B}{{K}_{0}} for \frac{α T}{4} < t + {τ}_{1} \leq \frac{T}{4} ( 2 - α )$$

whilst for the negative half-cycle

$$- \vert v ( t + τ - 1 ) \vert \leq - \frac{B}{{K}_{0}} for \frac{T}{4} ( 2 + α ) < t + {τ}_{1} \leq \frac{T}{4} ( 4 - α ) .$$

The constant B and angle α are related by

$$α = \frac{2}{π} a sin ( \frac{B}{{AK}_{0}} ) . \qquad ( A 13 )$$

For all possible values of AK₀, the periodicity and symmetry of i(t+τ₂) are preserved. Thus the Fourier series describing i(t+τ₂) is of the form

$$i ( t + {τ}_{2} ) = {b}_{1} sin {ω}_{0} ( t + {τ}_{2} ) + {{\sum }_{3}}^{∞} {b}_{n} sin n {ω}_{0} ( t + {τ}_{2} ) \\ n = 2 m + 1 for m = 1 , 2 , 3 , … , \qquad ( A 14 )$$

with coefficients

$$\begin{matrix} {b}_{1} = {AK}_{0} ( α - \frac{1}{π} sin ( π α ) ) + \frac{4 B}{π} cos ( \frac{π}{2} α ) , & ( A 15 a ) \\ {b}_{n} = \frac{2 {AK}_{0}}{π} \{ \frac{1}{( 1 - n )} sin ( ( 1 - n ) \frac{π}{2} α ) - \frac{1}{( 1 + n )} sin ( ( 1 + n ) \frac{π}{2} α ) \} + \frac{4 B}{n π} cos ( n \frac{π}{2} α ) & ( A15b )\end{matrix}$$

For constant B and increasing AK₀, the fraction α decreases and i(t+τ₂) tends to a square wave with fundamental frequency component φ₀. FIGS. A2D-G illustrate i(t+τ₂) for increasing A. FIG. A2G illustrates the waveform for the limiting case AK>>B, a→0. When the latter condition is fulfilled, the power in the signal i(t+τ₂) at the fundamental frequency φ₀ is given by

$${P}_{0} = {( \frac{4 B}{π} )}^{2} . \qquad ( A16 )$$

Whilst the total power is the summation

$$P = {P}_{0} + {\sum }_{3}^{∞} {( \frac{4 B}{n π} )}^{2} \\ n = 2 m + 1 for m = 1 , 2 , 3 , … \qquad ( A 17 )$$

The summation (A17) has a finite limit:

P=2B². (A18)

Thus as AK₀→d where d>>B and a→0, the ratio P₀/P tends to a finite limit S₁;

$${S}_{l} = \frac{8}{{π}^{2}} = 0.8106 . \qquad ( A 19 )$$

1.4 oN-LACE signal characteristics: asymmetrical input signal

The Fourier analysis of the previous Section may be extended to input waveforms of lower symmetry. For the purposes of illustration we consider the simple asymmetric input function depicted in FIG. A4 for which a single signal period T comprises a symmetrical positive cycle of duration βT and peak amplitude A₁ and a symmetrical negative cycle of duration (1-β)T of peak amplitude A₂ where β≠0.5. We derive the Fourier representation of the asymmetric output signal (1-β) of the oN-LACE in the large-signal regime for the particular case that the positive and negative amplitude thresholds characteristic of the oN-LACE have magnitude B₁ and B₂ respectively, that the small-signal regime is characterized by a certain constant dynamic gain K₀ independent of the polarity of the input signal v(t+τ₂), that the large-signal dynamic gain is zero and that there is no transitional signal regime.

In the limit of large AK₀ i.e. in the large-signal regime, i(t+τ₂) tends to an asymmetric square wave φ₀ as depicted in FIG. A5. Thus, the Fourier series describing i(t+τ₂) is of the form

$$i ( t + {τ}_{2} ) = {b}_{0} + {\sum }_{1}^{∞} {b}_{m} cos m {ω}_{0} ( t + {τ}_{2} ) \\ m = 1 , 2 , 3 , … \qquad ( A20 )$$

with coefficients

$$\begin{matrix}{b}_{0} = β ( {B}_{1} + {B}_{2} ) - {B}_{2} , & ( A 21 a ) \\ {b}_{m} = \frac{2 ( {B}_{1} + {B}_{2} )}{m π} sin ( m β π ) . & ( A 21 b )\end{matrix}$$

For the limiting case as AK₀→d where d>>B and a→0, the power in the signal i(t+τ₂) at the fundamental frequency φ₀ is given by

$${P}_{0} = {( \frac{2 ( {B}_{1} + {B}_{2} )}{π} )}^{2} {sin}^{2} ( β π ) , \qquad ( A 22 )$$

which for B₁=B₂=B (FIG. A6) reduces to

$${P}_{0} = {( \frac{4 B}{π} )}^{2} {sin}^{2} ( β π ) . \qquad ( A 23 )$$

In a particular realization of the oN-LACE using analogue semiconductor components an input-output device characteristic of the form

i(t+τ₂)=k₁tanh(k₂v(t+τ₁)) (A24)

is achieved where k₁ and k₂ are constants. Such a characteristic is shown in FIG. A7 and has the characteristics of an almost ideal oN-LACE: the small-signal quasi-linear signal regime (SS) is approximately entirely linear, the transitional regime (T) is very narrow, and the large-signal (LS) dynamic gain is zero.

1.5 ‘Mode-tracking’ performance of the acoustic oscillator

In certain ‘mode-tracking’ implementations of the acoustic oscillators described by this invention (which may involve either substantially propagating or substantially standing acoustic waves within the active region of the acoustic structure), a resonant mode of the acoustic structure, the frequency of which varies in time, defines the operating frequency of the oscillator. In such mode-tracking implementations, the oscillator controller responds to discrete or continuous changes in the frequency corresponding to the resonant mode, (such as might be brought about by physical changes in the acoustic structure), bringing about a corresponding and approximately instantaneous discrete or continuous compensating variation in the operating frequency of the oscillator. For optimal mode-tracking performance, it is desirable that the amplitude control element within the oscillator controller is of the optimal type described in above. In this Section, we outline why such an oN-LACE component offers superior performance over a general non-linear amplitude control element.

With reference to FIG. 4, acoustic mode-tracking applications require that the preferred operating frequency of the acoustic oscillator φ₀ is a frequency corresponding to a resonant mode of the equivalent electrical system i.e.

$${ω}_{0} = \frac{1}{\sqrt{{L}_{E} {C}_{E}}} . \qquad ( A25 )$$

Note that in acoustic mode-tracking implementations of the acoustic oscillator, it is not necessarily the case that the acoustic structure has a single resonance frequency. In certain applications, the acoustic structure may have a significant multiplicity of resonant modes, one of which it is desirable to select as the operating frequency of the acoustic oscillator. For any system with multiple resonant modes, an equivalent lumped electrical circuit of the form described may be defined which describes its behaviour in the region of each mode. Thus the i^{th} resonance frequency may be expressed in the form

$${ω}_{0 i} = \frac{1}{\sqrt{{L}_{Ei} {C}_{Ei}}} .$$

A stimulus of finite duration applied to the resonant acoustic structure at φ₀ gives rise to a response at the same frequency which decays at a rate α_{d} determined by the system damping ratio ξ equivalently. the quality factor, Q. The particular implementation of the acoustic oscillator with a nominal operating frequency defined by (A25) and a controller including a general non-linear amplitude control element (N-LACE) of equivalent conductance G_{NL}(v(t)) may be represented by the equivalent circuit of FIG. A1A. If a state of steady, constant amplitude oscillation of the system is to be attained, the N-LACE must consistently provide energy equal to that lost by virtue of the conductance G_{E}. This implies that if the steady-state amplitude of resonant oscillation is A₀and—for the sake of a simple illustration—we take the linear element H to be a unity gain all-pass component (see Section 1.0), we require that (with reference to FIGS. A1A and A1B)

$$\begin{matrix}\frac{1}{2} {G}_{E} {A}_{0}^{2} = \frac{1}{T} {\int }_{0}^{T} {G}_{NL} ( v ( t ) ) {A}_{0}^{2} {sin}^{2} {ω}_{0} t d t \\ = \frac{1}{T} {\int }_{0}^{T} i ( v ( t ) ) {A}_{0} sin {ω}_{0} t d t ,\end{matrix} \qquad ( A 26 )$$

where i(v(t)) is (as previously defined), the effective feedback current.

In a general implementation of the acoustic oscillator, the effective voltage dependent conductance of the N-LACE may take the form of a smooth, continuous function of the excitation amplitude—such as might be described or approximated by a polynomial series:

G_{NL}(V)=g₀+g₁V+g₂V²+g₃V³+g₄V⁴+. . . (A27a)

i.e.

$${G}_{NL} ( V ) = {g}_{0} + {\sum }_{i = 1}^{∞} {g}_{i} {V}^{i} \qquad ( A27b )$$

where V denotes the instantaneous magnitude of v(t) i.e. V=|v(t)| and for spontaneous oscillation of the closed-loop system, g₀ is necessarily a negative constant greater than G_{E}. The coefficients gᵢ may be either positive or negative. For the amplitude control element described by (A27b) and v(t)=A₀sin φ₀t, the steady oscillation condition (A26) is given accordingly by

$$\frac{1}{2} {G}_{E} {A}_{0}^{2} = \frac{1}{2} {g}_{0} {A}_{0}^{2} + \frac{3}{8} {g}_{2} {A}_{0}^{4} + \frac{5}{16} {g}_{4} {A}_{0}^{6} + … \qquad ( A28 )$$

However, in the case that the N-LACE is of the preferred, optimal type described above (G_{oNL} in FIG. A1C). in the steady-state oscillator regime the oN-LACE output i(V,t) has a particular power-spectral density (Sections 1.2-1.4) and an amplitude that takes a value that is generally approximately independent and preferably entirely independent of V.

The input-output characteristics of a general oN-LACE are described in detail above and in the main body of the application, here—for comparison with a general non-linear amplitude control element—we consider the particular case that the input to the oN-LACE is a symmetrical, monochromatic signal at φ₀: v(t+τ₂)=A₀ sin φ₀t and that the output of the oN-LACE. i(t+τ₂) is a square wave of amplitude B, locked in frequency and phase to v(t+τ₂) (i.e. the positive and negative amplitude thresholds characteristic of the oN-LACE have equal magnitude: (A10) holds), the small-signal regime is characterized by a certain constant dynamic gain K₀ independent of the polarity of the signal v(t₁+τ₁), the large-signal dynamic gain is zero and there is no transitional signal regime). In this particular case, the steady-state oscillation amplitude A₀ is found by solving;

$$\frac{1}{2} {G}_{E} {A}_{0}^{2} = \frac{1}{T} {\int }_{0}^{T} \frac{4 B}{π} {A}_{0} {sin}^{2} {ω}_{0} t d t , \qquad ( A29 )$$

thus

$${A}_{0} = \frac{4 B}{π {G}_{E}} . \qquad ( A30 )$$

In a general acoustic oscillator incorporating a general N-LACE such as is described by (A27b), small changes or fluctuations in the values of the coefficients g₀ and g₂ may have a profound effect on the amplitude of oscillation. As a result, such arrangements are may be temperamental, and a subsidiary slow-acting amplitude control-loop may be required to promote reliable operation. This subsidiary control-loop is undesirable for several reasons—it adds complexity, it can lead to squegging and parasitic oscillation of the acoustic oscillator system and it fundamentally limits the speed of the control-loop response to changing acoustic structure parameters.

In contrast, the oN-LACE that forms a part of the preferred embodiment of the acoustic oscillator provides—as evidenced by equation (A30)—a steady-state output that is independent of the actual negative conductance presented by the non-lineanty and thus the parameters of the real devices that make up the oN-LACE. Predictable, robust performance is thus promoted without the need for any subsidiary slow-acting control-loop.

1. An acoustic oscillator arrangement comprising:
an acoustic structure including at least one acoustic transmission path therethrough and having at least one mode;
a controller including an amplifier and a feedback network configured together so as to provide a positive feedback oscillator for exciting a mode of the acoustic structure, the controller having an input and an output;
an acoustic transmitter in communication with the controller output for generating an acoustic signal from the output of the controller, and for launching that acoustic signal into an acoustic system forming part of the acoustic structure; and
an acoustic receiver in communication with the controller input, for receiving an acoustic signal from the acoustic system which is fed back to the acoustic system via the controller input, the length of the acoustic transmission path between the acoustic transmitter and acoustic receiver being adjustable; characterized in that the feedback network includes a non-linear amplitude control element (N-LACE), a frequency dependent gain element having an electronic transfer function, and a phase compensator.

2. The acoustic oscillator arrangement of claim 1, wherein the non-linear amplitude control element (N-LACE) has an input and an output, and wherein the N-LACE is configured to provide an output signal at the N-LACE output which has a magnitude that has a negative second derivative with respect to an input signal supplied to the N-LACE input.

3. The acoustic oscillator arrangement of claim 1, wherein the N-LACE comprises an active device with a negative differential conductance.

4. The acoustic oscillator arrangement of claim 1, wherein the NLACE comprises a differential amplifier arranged as a long tailed pair.

5. The acoustic oscillator arrangement of claim 4, wherein the differential amplifier comprises first and second bipolar junction transistors, wherein each of the first and second bipolar junction transistors comprises an emitter connected in common to a first potential via a tail load, and wherein each of the first and second bipolar junction transistors comprises a collector that is connected to second and third potentials via first and second loads respectively, the controller amplifier output being supplied as an input to the base of the second transistor when the base of the first transistor is held at a fixed potential.

6. The acoustic oscillator arrangement of claim 5, wherein the first load is a resistance connected between the collector of the first transistor and the second potential, wherein the second load is also a resistance connected between the collector of the second transistor and the third potential; wherein the second and third potentials are the same and are provided by a common supply voltage; and wherein the controller output is coupled from the collector of the first transistor.

7. The acoustic oscillator arrangement of claim 6, wherein the transistors are each NPN bipolar junction transistors, wherein the emitters are connected to a negative voltage rail via the tail load, wherein the collectors are connected to a common positive voltage rail via the first and second loads respectively, and wherein the base of the first transistor is grounded.

8. The acoustic oscillator arrangement of claim 5, wherein the tail load is variable, wherein the first load is an active load connected between the collector of the first transistor and the second potential, and wherein the second potential is greater than the third potential to which the second transistor's collector is coupled.

9. The acoustic oscillator arrangement of any claim 4, wherein the acoustic system is arranged to generate an electrical control signal, and wherein the tail load of the long tailed pair is automatically varied by the said electrical control signal.

10. The acoustic oscillator arrangement of claim 1, further comprising one or more signal processing elements positioned in one or more of the controller, the path between the controller and the acoustic transmitter, and the path between the controller and the acoustic receiver, the one or more signal processing elements being configured to stabilize the positive feedback oscillator in a selected operating mode.

11. The acoustic oscillator arrangement of claim 10, wherein the one or more signal processing elements are configured
(a) to provide a frequency dependent gain with a single maximum at or incorporating a selected resonant mode of the acoustic structure; and
(b) to introduce a phase shift at or around the frequency of the selected resonant mode which, in combination with any other phase shifts in the controller, gives an overall loop phase shift of substantially 360n degrees, where n is an integer>=0.

12. The acoustic oscillator arrangement of claim 10, wherein the one or more signal processing elements includes a means for varying an electrical frequency dependent transfer function so as to permit switching between a first mode at a frequency f1, and at least one further mode at a different frequency f2.

13. The acoustic oscillator arrangement of claim 1, wherein the acoustic transmitter and the acoustic receiver are formed as physically separate components, located at different positions relative to the acoustic system.

14. The acoustic oscillator arrangement of claim 1, wherein the acoustic transmitter and the acoustic receiver are formed as a single transceiver.

15. The acoustic oscillator arrangement of claim 13, further comprising an acoustic reflector, mounted at a location on, in or adjacent the acoustic system, but separate from the acoustic transceiver, for reflecting the acoustic signal launched from the acoustic transmitter back towards the acoustic receiver.

16. The acoustic oscillator arrangement of claim 1, further comprising signal acquisition means for performing at least one of: acquiring the signals within the acoustic oscillator arrangement or monitoring the signals within the acoustic oscillator arrangement.

17. The acoustic oscillator arrangement of claim 16, wherein the signal acquisition means includes at least one of a frequency counter or a demodulator for monitoring changes in a quality factor Q of the acoustic structure.

18. The acoustic oscillator arrangement of claim 1, wherein at least one of the acoustic transducer or the acoustic receiver are moveable relative to the acoustic system so as to permit the length of the acoustic transmission path to be adjusted.

19. The acoustic oscillator arrangement of claim 15, wherein the acoustic reflector is moveable relative to at least one of the acoustic transmitter or acoustic receiver so as to permit a change in the transmission path length.

20. The acoustic oscillator arrangement claim 1, wherein one or more dimensions of the acoustic structure or a geometric arrangement of the acoustic structure are adjustable so as to permit the length of the acoustic transmission path to be adjusted.

21. The acoustic oscillator arrangement of claim 16,
wherein the acoustic oscillator arrangement is configured to perform at least one of: testing bulk material or characterizing bulk material,
wherein the acoustic system is provided by the bulk material to be tested or wherein the controller is configured to generate a substantially propagating wave within the bulk material, and
wherein the signal acquisition means is configured to provide an output related to the amplitude of the oscillator operation so as to monitor losses in the transmission path resulting from artifacts within the bulk material.

22. The acoustic oscillator arrangement of claim 21, wherein the signal acquisition means is configured to compare the root mean square amplitude of the controller output signal with the controller input signal.

23. The acoustic oscillator arrangement of claim 16, wherein the acoustic oscillator arrangement is configured as an acoustic levitator for capturing and manipulating an object without physical contact,
wherein the acoustic system comprises a levitation cell having a levitation volume for receiving the object to be manipulated,
wherein the controller is configured to generate a substantially standing wave within the levitation volume of the levitation cell, and
wherein the signal acquisition means is configured to provide an output related to one or both of the controller output signal frequency and the oscillator amplitude.

24. The acoustic oscillator arrangement of claim 1, wherein the signal acquisition means is configured to compare the root mean square amplitude of the controller output signal with the root mean square controller input signal amplitude so as to provide an indication of changes in the quality factor (Q) of the acoustic resonance.

25. The acoustic oscillator arrangement of claim 23, wherein the levitation cell comprises a fluid inlet for introducing a liquid or gaseous medium into the levitation cell.

26. The acoustic oscillator arrangement of claim 23, wherein the levitation cell is generally ‘U’ or ‘V’ shaped, wherein the acoustic transmitter is mounted upon a first arm of the levitation cell, wherein an acoustic reflector is mounted upon a second, opposed arm of the levitation cell, and wherein the acoustic receiver is mounted or suspended within the levitation volume defined between the first and second arms of the levitation cell.

27. The acoustic oscillator arrangement of claim 26, wherein the acoustic receiver is suspended within the levitation volume independently of the levitation cell, and wherein a base of the ‘U’ or ‘V’ shaped levitation cell is mounted upon a translation stage so as to permit movement of the levitation cell with the mounted acoustic transmitter and reflector relative to the independent acoustic receiver.

28. The acoustic oscillator arrangement of claim 16,
wherein the acoustic oscillator arrangement is configured as an acoustic filter for filtering particles from a fluid or quasi solid medium,
wherein the acoustic system comprises a filtration chamber defining a filtration channel between an inlet and an outlet,
wherein the controller is configured to generate a substantially standing wave within the filtration channel, and
wherein the signal acquisition means is configured to provide an output related to one or both of the controller output signal frequency and the oscillator amplitude.

29. The acoustic oscillator arrangement of claim 28, wherein the acoustic transmitter is mounted to a first side wall of the filtration chamber, and wherein an acoustic reflector is mounted to a second opposed side wall so that acoustic waves are launched into the filtration channel in a direction generally transverse to a flow direction in that filtration channel.

30. A method of exciting a resonant mode in an acoustic system of an acoustic oscillator arrangement, comprising:
providing a positive feedback acoustic oscillator arrangement having a controller, the controller including a controller feedback network with an amplifier, a nonlinear amplitude control element, a frequency dependent gain element having an electronic transfer function, and a phase compensator;
receiving a signal generated by the positive feedback oscillator at an acoustic transmitter, and generating an acoustic signal therefrom;
launching the acoustic signal from the acoustic transmitter into an acoustic system having at least one resonant mode and defining an acoustic path;
receiving the acoustic signal at an acoustic receiver in communication with the acoustic system; and
feeding the received acoustic signal back to the controller of the oscillator.

31. A method of tracking a resonant mode m1 in an acoustic structure of an acoustic oscillator arrangement, comprising:
exciting the resonant mode m1 at a frequency f1,
causing or allowing the frequency f1 of the resonant mode to shift over time over a range of frequencies f1−df to f1+df where df<=f1/Q; and
tracking the resonant mode as it shifts over time, by configuring the frequency dependent gain element to be capable of supplying a gain and a phase shift so as to make the overall loop gain around the positive feedback oscillator unity and the loop phase shift substantially 360.n degrees, where n is an integer>=0 over the range f1−df to f1+df.

32. A method of switching between resonant modes in an acoustic system of an acoustic oscillator arrangement, the acoustic system having a plurality of resonant modes, the method comprising:
selecting and exciting a first mode of the plurality of modes at a first modal-frequency f1; and
moving at least one of the acoustic transmitter or the acoustic receiver relative to the acoustic system so as to cause the acoustic oscillator arrangement to excite a second resonant mode of the acoustic system at a frequency f2 different from f1, in accordance with the method of claim 30.

33. A method of switching between resonant modes in an acoustic structure of an acoustic oscillator arrangement, the acoustic structure having a plurality of resonant modes, the method comprising:
selecting and exciting a first mode of the plurality of modes at a first modal frequency f1;
providing a signal processing element within the acoustic oscillator arrangement, having at least one of a frequency dependent phase shift or gain; and
adjusting at least one of the frequency dependent phase shift or the gain so as to cause the acoustic oscillator arrangement to excite a second resonant mode of the acoustic structure at a frequency f2 different from f1.

34. The method of switching of claim 32, wherein selecting and exciting the first of the plurality of modes comprises,
shifting the frequency f1 of the first mode over time, over a range of frequencies f1−df1 to f1+df1 where df1<=f1/Q1, and
tracking the first resonant mode as it shifts over time, by configuring the frequency dependent gain element to supply a gain and phase-shift which makes the overall loop gain around the positive feedback oscillator unity and the loop phase shift substantially 360.n degrees, where n is an integer>=0 over the ranges of frequencies f1−df1 to f1+df1 where df1<=f1/Q1; and
wherein selecting and exciting the second of the plurality of modes comprises,
shifting the frequency f2 of the second mode over time, over a range of frequencies f2−df2 to f2+df2 where df2<=f2/Q2, and
tracking the second resonant mode as it shifts over time, by configuring the frequency dependent gain element to supply a gain and phase shift which makes the overall loop gain around the positive feedback oscillator unity and the loop phase shift substantially 360.n degrees, where n is an integer>=0 over the ranges of frequencies f2−df2 to f2+df2 where df2<=f2/Q2; and
further wherein (f2−f1)>>2df1; (f2−f1)>>2df2.

35. The method of claim 30, wherein launching the acoustic signal from the acoustic transmitter into the acoustic system comprises launching both a standing (stationary) wave and a propagating acoustic wave into the acoustic system, the proportion of each of the standing (stationary) wave and the propagating acoustic wave being unequal.

36. The method of claim 35, wherein launching the acoustic signal from the acoustic transmitter into the acoustic system comprises launching a substantially standing acoustic wave and a relatively smaller proportion of a propagating wave into the acoustic system.

37. The method of claim 35, wherein launching the acoustic signal from the acoustic transmitter into the acoustic system comprises launching a substantially propagating acoustic wave and a relatively smaller proportion of a standing wave into the system.
